(19) United States
(12) Patent Application Publication
(10) Pub. No.: US 2016/0293972 A1
(43) Pub. Date: Oct. 6, 2016

(54) CARBON-BASED CATALYSTS FOR OXYGEN REDUCTION REACTIONS

(71) Applicant: WILLIAM MARSH RICE UNIVERSITY, Houston, TX (US)

(72) Inventors: James M. TOUR, Bellaire, TX (US); Pulickel M AJAYAN, Houston, TX (US); Yongji GONG, Houston, TX (US); Huilong FEI, Houston, TX (US); Shubin YANG, Houston, TX (US)

(21) Appl. No.: 15/038,157

(22) PCT Filed: Nov. 20, 2014
(86) PCT No.: PCT/US14/66622

§ 371 Date: May 20, 2016

Related U.S. Application Data
(60) Provisional application No. 61/906,531, filed on Nov. 20, 2013.

(51) Int. Cl. H01M 4/96; H01M 4/86; C01B 13/14; C01B 5/00; C01B 15/029; H01M 4/90; C01B 31/36

(52) U.S. Cl. CPC H01M 4/96; H01M 4/90; H01M 4/8668; C01B 31/36; C01B 5/00; C01B 15/029; C01B 13/14

(57) ABSTRACT

In some embodiments, the present disclosure pertains to catalysts for mediating oxygen reduction reactions, such as the conversion of oxygen to at least one of H₂O, H₂O₂, O₂⁻, OH⁻, and combinations thereof. In some embodiments, the present disclosure pertains to methods of utilizing the catalysts to mediate oxygen reduction reactions. In some embodiments, the catalyst includes a carbon source and a dopant associated with the carbon source. In some embodiments, the catalyst has a three-dimensional structure, a density ranging from about 1 mg/cm³ to about 10 mg/cm³, and a surface area ranging from about 100 m²/g to about 1,000 m²/g. In some embodiments, the carbon source includes graphene nanoribbons, and the dopant includes boron-nitrogen heteroatoms. In some embodiments, the dopant is covalently associated with the edges of the carbon source. Additional embodiments of the present disclosure pertain to methods of making the aforementioned catalysts.

### CROSS-REFERENCE TO RELATED APPLICATIONS

This application claims priority to U.S. Provisional Patent Application No. 61/906,531, filed on Nov. 20, 2013. The entirety of the aforementioned application is incorporated herein by reference.

### STATEMENT REGARDING FEDERALLY SPONSORED RESEARCH

This invention was made with government support under Grant No. DMR-0928297, awarded by the National Science Foundation; Grant No. W911NF-11-1-0362, awarded by the U.S. Department of Defense; Grant No. FA9550-12-1-0035, awarded by the U.S. Department of Defense; Grant No. N000014-09-1-1066, awarded by the U.S. Department of Defense; Grant No. FA9550-09-1-0581, awarded by the U.S. Department of Defense; Grant No. CNS-0821727, awarded by the National Science Foundation; and Grant No. OCI-0959097, awarded by the National Science Foundation. The government has certain rights in the invention.

### BACKGROUND

Current catalysts for mediating oxygen reduction reactions have numerous limitations, including low catalytic activity, low durability, high-costs, and scarcity of starting materials. As such, a need exists for the development of improved catalysts for mediating oxygen reduction reactions.

### SUMMARY

In some embodiments, the present disclosure pertains to novel catalysts for mediating oxygen reduction reactions. In some embodiments, the present disclosure pertains to methods of mediating oxygen reduction reactions by exposing the catalysts of the present disclosure to oxygen. In some embodiments, the exposure of the catalysts to oxygen results in conversion of oxygen to at least one of H₂O, H₂O₂, O₂⁻, OH⁻, and combinations thereof.

In some embodiments, the catalysts of the present disclosure include a carbon source and a dopant associated with the carbon source. In some embodiments, the catalysts of the present disclosure also include a plurality of active sites for mediating oxygen reduction reactions. In some embodiments, the catalysts of the present disclosure consist essentially of the carbon source and the dopant. In some embodiments, the catalysts of the present disclosure are substantially free of metals. In some embodiments, the catalysts of the present disclosure have a three-dimensional structure, a density ranging from about 1 mg/cm³ to about 10 mg/cm³, and a surface area ranging from about 100 m²/g to about 1,000 m²/g. In some embodiments, the catalysts of the present disclosure are associated with an energy conversion device, such as a fuel cell.

In some embodiments, the carbon source in the catalysts of the present disclosure includes at least one of carbon nanoribbons, graphene nanoribbons, functionalized graphene nanoribbons, graphene oxide nanoribbons, reduced graphene oxide nanoribbons, and combinations thereof. In some embodiments, the carbon source includes graphene nanoribbons, such as graphene nanoribbons derived from carbon nanotubes.

In some embodiments, the dopant that is associated with the carbon source includes, without limitation, boron, nitrogen, sulfur, phosphorus, heteroatoms thereof, and combinations thereof. In some embodiments, the dopant is a heteroatom that includes boron and nitrogen. In some embodiments, the dopant is covalently associated with the carbon source. In some embodiments, the dopant is covalently associated with the edges of the carbon source.

Additional embodiments of the present disclosure pertain to methods of making the catalysts of the present disclosure. In some embodiments, the methods of the present disclosure include assembling a carbon source into a three-dimensional structure and doping the carbon source with a dopant. In some embodiments, the carbon source is assembled into a three-dimensional structure through hydrothermal treatment of the carbon source. In some embodiments, the carbon source is assembled into a three-dimensional structure through the cross-linking of the carbon source.

### DESCRIPTION OF THE FIGURES

FIG. 1 provides schemes of a method of mediating oxgen reduction reactions by utilitizing the catalysts of the present disclosure (FIG. 1A) and a method of making the catalysts (FIG. 1B).

FIG. 2 provides a schematic diagram of a method of preparing the catalysts of the present disclosure (also referred to as electrocatalysts). Graphene oxide nanoribbons (GONR) assemble into three-dimensional (3D) aerogels in aqueous solutions by hydrothermal treatment at 180° C. (step 1). Thereafter, GONR aerogels are doped with boric acid and ammonia using a chemical vapor deposition (CVD) method to generate 3D boron nitride carbon nanoribbon (BNC NR) aerogels (also referred to as BNC NR electrocatalysts) (step 2).

FIG. 3 shows data relating to the structural characterization of the BNC NR electrocatalysts. FIG. 3A is a photograph showing the morphology of BNC NR aerogels. FIG. 3B is a schematic diagram of 3D BNC NR aerogels. FIG. 3C is a transmission electron microscopy (TEM) image of the BNC NR aerogels, which shows its 3D porous structure. FIG. 3D is a scanning TEM annular dark field (STEM ADF) image of BNC NR with ˜10 wt % BN. The corresponding elemental mapping of carbon (FIG. 3E), boron (FIG. 3F) and nitrogen (FIG. 3G) are also shown. High-resolution x-ray photoelectron spectroscopy (XPS) spectra of C 1s (FIG. 3H), B 1s (FIG. 31) and N1s (FIG. 3J) from BNC NR aerogels are shown with different B/N substitution levels from 5.9 wt % to 24.2 wt %.

FIG. 4 provides scanning electron microscopy (SEM), TEM and STEM characterization of BNC NR electrocatalysts. FIGS. 4A-B provide SEM images at different magnifications. The images show the highly porous network structure of BNC NR aerogels. FIG. 4C is a TEM image that shows several BNC NR ribbons connected to each other. FIG. 4D shows an STEM ADF image showing the lattice of BNC NR. The bright white dots here are silicon atoms, which do not play a role in the ORR reaction. FIG. 4E shows an electron energy loss spectroscopy (EELS) sum spectrum from the whole elemental mapping region shown in FIGS. 3D-G. The B:C:N atomic ratio is 5:89:6.

FIG. 5 shows specific surface area and pore distribution of BNC NR aerogels. FIG. 5A shows nitrogen adsorption/desorption isotherms. The isotherms further reveal that the BNC NR aerogels have much more porous structures than in BNC NR. The Brunauer-Emmett-Teller (BET) surface areas of the BNC NR aerogels are 875 m²/g and 201 m²/g, respectively. FIG. 5B shows the pore diameter distributions of the BNC NR aerogels, revealing that the pore diameters in BNC NR aerogels are in the range of 2 to 110 nm.

FIG. 6 provides SEM images of GNR powders. FIGS. 6A-B provide SEM images with different magnifications. The SEM images show the morphology of GNR powders, where GNRs aggregated and no pores were found.

FIG. 7 shows an XPS characterization of the BNC NR aerogels. Typical XPS survey spectra of aerogels before and after BN doping are shown.

FIG. 8 shows Raman spectra of GONR before and after BN doping. The stronger D peak of BNC NR can be attributed to the doping effect, and also to the overlapping BN E_{2g} peak at 1363 cm⁻¹ that appeared after doping.

FIG. 9 shows the electrocatalytic characterization of BNC NR aerogels with different doping concentrations of BN. FIG. 9A shows the cyclic voltammetry (CV) of BNC-2 NR catalysts in O₂- or Ar-saturated 0.1 M KOH electrolyte. FIG. 9B shows the disk current densities of the rotating ring disk electrode (RRDE) versus potential derived from BNC-2, N-doped GNR aerogels and commercial Pt/C catalyst. FIG. 9C shows disk current densities of the RRDE versus potential derived from BNC NR aerogels with different compositions in oxygen-saturated 0.1 M KOH. The corresponding H₂O₂ percentage of each sample was calculated from the RRDE disk and ring current. FIG. 9D shows a comparison of the ORR performances of different BNC NR aerogels and commercial Pt/C catalyst in kinetic current densities (J_{K}) and electron transfer number (n).

FIG. 10 shows electrocatalyst characterizations. FIG. 10A shows CVs of Pt/C catalysts in O₂-saturated (red) and Ar-saturated (black) 0.1 M KOH. The peak of the ORR reaction appears at −0.17 V. FIG. 10B shows a typical RRDE test of BNC-1, which shows the current density from the ring and disk at 400 rpm in O₂-saturated 0.1 M KOH.

FIG. 11 shows the conversion of potential vs. Ag/AgCl to potential vs. reversible hydrogen electrode (RHE) (FIG. 11A). The onset potentials and E_{1/2} (vs. RHE) of Pt/C and different BNC NR samples are also shown (FIG. 11B).

FIG. 12 shows disk current densities of the RRDE versus potential derived from BNC-2 commercial Pt/C catalysts. Here, Hg/HgO reference was used to remove the concern of possible problems from using Ag/AgCl reference in alkaline solution.

FIG. 13 shows oxidative reduction reaction (ORR) performance of the GONR without any B or N doping.

FIG. 14 shows the relationship between onset potential, electron transfer numbers and the concentration of BN in BNC NR aerogels. The graph shows that the electron transfer number and kinetic limiting current density decreases with more BN doping. Meanwhile, the onset potential first increased and then decreased with more BN doping.

FIG. 15 shows rotating disk electrode (RDE) linear sweep voltammograms of BNC-1 sample in O₂-saturated 0.1 M KOH with various rotation rates (225 rpm, 400 rpm, 625 rpm, 900 rpm, 1225 rpm and 1600 rpm from top to bottom, respectively) at a scan rate of 5 mV/s (FIG. 15A). The Koutecky-Levich plots of BNC-1 derived from RDE voltammograms in FIG. 15A at different electrode potentials (−0.35 V, −0.40 V and −0.45 V from top to bottom, respectively) are also shown (FIG. 15B).

FIG. 16 shows the different electrocatalyst performance of BNC-1 samples in the form of an aerogel or powder (FIG. 16A). BNC-2 shows the best electrocatalyst performance in acid, which is similar to Pt/C (FIG. 16B).

FIG. 17 shows an enlarged spectrum of BNC-1 at around 645 eV with 30 sweeps (FIG. 17A), demonstrating the absence of Mn from BNC-1. The ORR performance of BNC-1 before and after purification of rudimental metal ions is also shown (FIG. 17B).

FIG. 18 shows various theoretical simulations of BNC NR aerogels. FIG. 18A shows schematic representations of structural models along with some selected intermediate states. The interface (a line of zigzag BN chain) could either represent the bulk interface where the BN and graphene domains meet, or be saturated by hydrogen atoms forming edge interfaces. FIG. 18B shows the free energy diagram for ORR on different models for comparison under the conditions of pH=13 and the maximum potential allowed by thermodynamics. The proposed associative mechanism involves the following steps: (1) O₂+2H₂O+*+4e⁻→O₂*+2H₂O+4e⁻; (2) O₂*+2H₂O+4e⁻→OOH*+H₂O+OH⁻+3e⁻; (3) OOH*+H₂O+OH⁻+3e⁻→O*+H₂O+2OH⁻+2e⁻; (4) O*+H₂O+2OH⁻+2e⁻→OH*+3OH⁻+e⁻; (5) OH*+3OH⁻+e⁻→4OH⁻+*, where * denotes an active site on the catalyst surface.

FIG. 19 shows ORR performances of BNC-2 NR aerogel catalyst for assessment of methanol tolerance and durability. FIG. 19A shows current density-time responses at −0.4 V in 0.1 M KOH on BNC-2 and Pt-C electrode (900 rpm) followed by introduction of O₂ and methanol (0.3 M). FIG. 19B shows cycle performance of BNC-2 before and after 5000 potential cycles in O₂-saturated 0.1 M KOH.

FIG. 20 shows Bader charge calculated for different configurations. The values of net charges for C, B, and N atoms are shown in black, pink and blue, respectively. All the active B atoms possess a similar positive charge.

FIG. 21 shows spin charge density isosurfaces for Edge and Bulk doping cases before (FIG. 21A) and after (FIG. 21B) O₂ adsorption, respectively. The claret-red and cyan isosurfaces with isovalues of 0.02 eV/Å³ in spin charge density plots represent spin-up and spin-down channels, respectively.

FIG. 22 shows density of states (DOS) plots for O₂ adsorption on Edge ZZ (zigzag edge, identical to Edge case in Example 1) (FIG. 22A), Bulk (FIG. 22B), and Edge AC (one BN pair doped in the armchair edge) cases (FIG. 22C), respectively. Fermi levels are indicated by the green dashed lines.

FIG. 23 provides a free energy diagram for ORR on GNRs with different BN-edge-doping modes: one BN pair doped in the armchair (Edge AC) and zigzag (Edge ZZ) edges. The latter one is identical to the Edge case in Example 1.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Due to the kinetic sluggishness of oxygen reduction reactions (ORR) (e.g., ORRs with four-electron transfer pathways in electrodes), the development of new active electrocatalysts for ORRs has become a key to boost the practical applications of fuel cells and metal-air batteries. Although platinum (Pt) and its alloys exhibit high activity for ORR, their performance has been overshadowed by the high-cost and scarcity of Pt, and by the reduced thermal efficiency caused by substantial overpotential for the ORR.

Hence, efforts have been devoted to substitute Pt-based catalysts by employing non-precious metal catalysts and preferably metal-free catalysts. For instance, various heteroatom (nitrogen, sulphur or phosphorus)-doped carbon nanotubes, mesoporous carbons and graphene sheets have been widely explored for ORR catalysts via various synthesis approaches.

In general, the adsorption of oxygen and formation of superoxide through a one-electron reduction on metal-free catalysts has been suggested as the initial ORR steps. O₂ adsorption is proposed to be the rate-determining step. Since oxygen is preferred to be adsorbed onto the exposed edges of catalysts rather than its basal planes, it is suggested that the edges of catalysts possess high ORR activity while the basal planes remain virtually ORR inactive. Thus, it is envisioned that edge-abundant, nitrogen-doped graphene would facilitate the formation of catalytic sites for ORR.

Accordingly, unique carbon nanotube-nanoribbon complexes with controllable nitrogen doping have been recently explored via partially unzipping carbon nanotubes and subsequent annealing under an NH₃ atmosphere. Such catalysts have shown enhanced catalytic activity for ORR. However, in rotating-disk electrode (RDE) polarization studies, their ORR onset potentials and half-wave potentials (E_{1/2}) are still lower than those of commercially available Pt catalysts. This would result in high overpotentials of fuel cells at practical operating current densities, and cause low thermal efficiency. Thus, a need exists for the design and fabrication of more effective and efficient ORR catalysts. The present disclosure addresses this need.

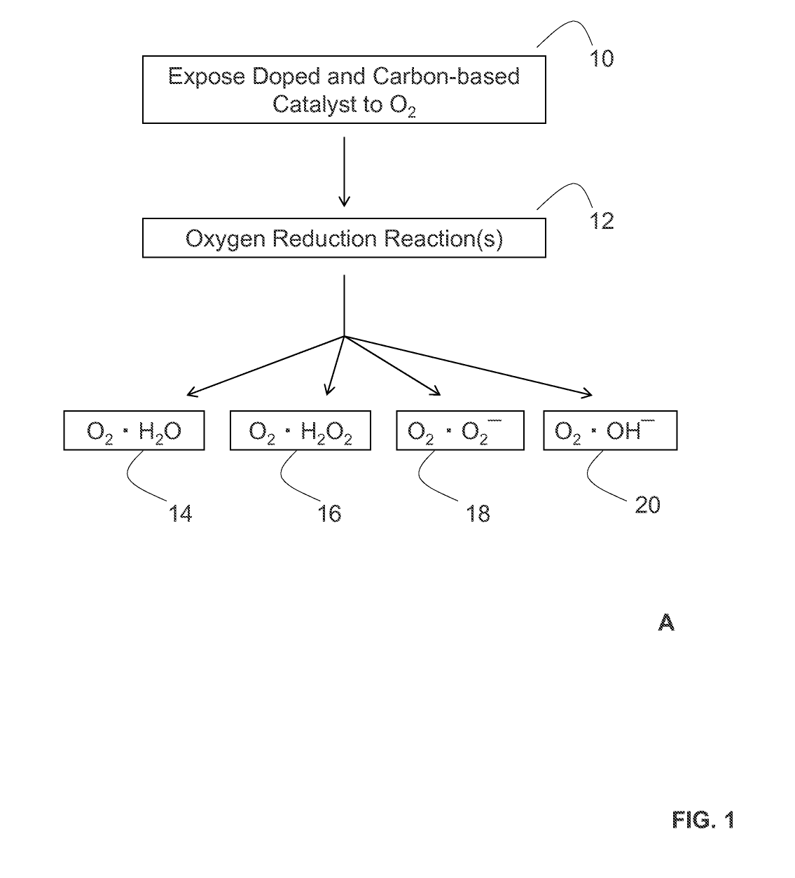

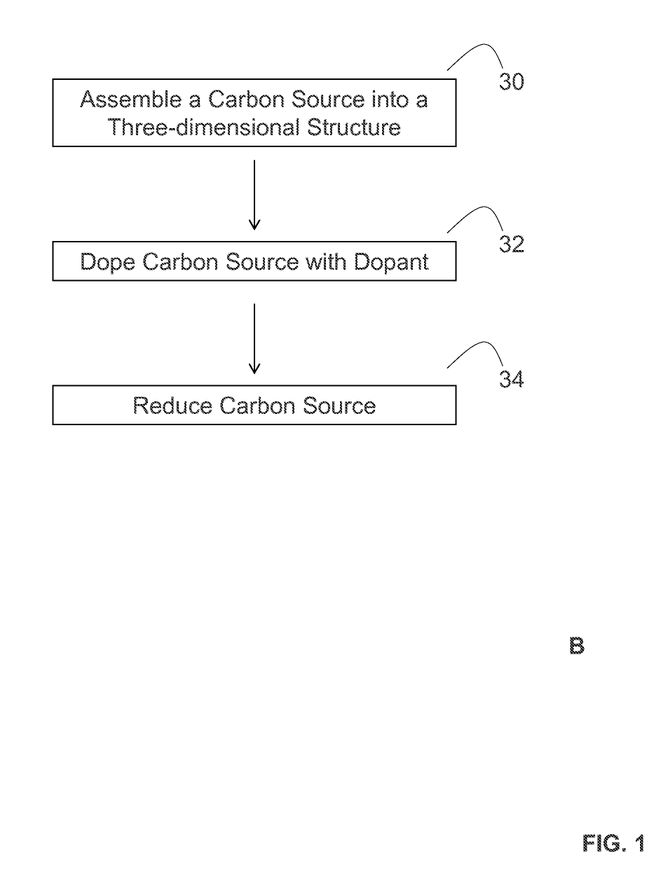

In some embodiments, the present disclosure pertains to novel catalysts for mediating oxygen reduction reactions. In some embodiments, the catalysts include a carbon source and a dopant associated with the carbon source. In some embodiments, the present disclosure pertains to methods of mediating an oxygen reduction reaction by utilizing the catalysts of the present disclosure. In some embodiments that are illustrated in FIG. 1A, the methods of the present disclosure include exposing a doped and carbon-based catalyst to oxygen (step 10). In some embodiments, the exposing results in the initiation of one or more oxygen reduction reactions (step 12). In some embodiments, the oxygen reduction reactions include the conversion of oxygen to at least one of H₂O (step 14), H₂O₂ (step 16), O₂⁻ (step 18), OH⁻ (step 20), and combinations thereof.

As set forth in more detail herein, the methods of the present disclosure may expose oxygen to various types of catalysts in various environments to result in the initiation of various types of oxygen reduction reactions. As also set forth in more detail herein, the catalysts of the present disclosure may contain various carbon sources and dopants. The catalysts of the present disclosure may also have various structures and properties.

Exposing of Catalysts to Oxygen

Various methods may be utilized to expose the catalysts of the present disclosure to oxygen. In some embodiments, the exposing of the catalyst to oxygen includes incubating the catalyst with an oxygen source. In some embodiments, the exposing of the catalyst to oxygen includes placing the catalyst in an environment that is exposed to oxygen. In some embodiments, the exposing of the catalyst to oxygen includes placing the catalyst in an energy conversion device. In some embodiments, the energy conversion device is a fuel cell. In some embodiments, the energy conversion device is a battery, such as a metal-air battery or a lithium ion battery

In some embodiments, the exposing occurs in the presence of an electrolyte. In some embodiments, the electrolyte includes, without limitation, sodium (Na⁺), potassium (K⁺), calcium (Ca²⁺), magnesium (Mg²⁺), chloride (Cl⁻), hydrogen phosphate (HPO₄²⁻), hydrogen carbonate (HCO₃⁻), and combinations thereof.

In some embodiments, the exposing occurs in the presence of an electrical current. In some embodiments, the catalyst is associated with an electrically conductive surface that generates the electrical current. In some embodiments, the electrically conductive surface is an electrode, such as a cathode or an anode.

Without being bound by theory, it is envisioned that the exposure of catalysts to oxgen results in the adsorption of oxygen to the active sites of the catalyst. This in turn results in the initiation of one or more oxygen reduction reactions.

Oxygen Reduction Reactions

The catalysts of the present disclosure can mediate various types of oxygen reduction reactions. For instance, in some embodiments, the exposing of the catalyst to oxygen results in conversion of oxygen to H₂O. In some embodiments, the conversion of oxygen to H₂O occurs through a 4-electron reduction pathway.

In some embodiments, the exposing of the catalyst to oxygen results in conversion of oxygen to H₂O₂. In some embodiments, the conversion of oxygen to H₂O₂ occurs through a 2-electron reduction pathway. In some embodiments, the exposing of the catalyst to oxygen results in conversion of oxygen to O₂⁻. In some embodiments, the conversion of oxygen to O₂⁻ occurs through a 1-electron reduction pathway.

In some embodiments, the exposing of the catalyst to oxygen results in conversion of oxygen to OH⁻. In some embodiments, the conversion of oxygen to OH⁻ occurs through the following steps (where * denotes an active site on a catalyst surface):
(1) O₂+2H₂O+*+4e⁻→O₂*+2H₂O+4e⁻
(2) O₂*+2H₂O+4e⁻→OOH*+H₂O+OH⁻+3e⁻
(3) OOH*+H₂O+OH⁻+3e⁻→O*+H₂O+2OH⁻+2e⁻
(4) O*+H₂O+2OH⁻+2e⁻→OH*+3OH⁻+e⁻
(5) OH*+3OH⁻+e⁻→4OH⁻+*

Catalysts

The catalysts of the present disclosure generally include a carbon source and a dopant that is associated with the carbon source. In addition, the catalysts of the present disclosure generally include a plurality of active sites for mediating oxygen reduction reactions. In some embodiments, the catalysts of the present disclosure only include a carbon source and a dopant. In some embodiments, the catalysts of the present disclosure are substantially free of metals. In some embodiments, the catalysts of the present disclosure lack precious metals. As set forth in more detail herein, the catalysts of the present disclosure can include various types of carbon sources and dopants in various arrangements. In some embodiments, the catalysts of the present disclosure are referred to as electrocatalysts.

Carbon Sources

The catalysts of the present disclosure can include various types of carbon sources. In some embodiments, the carbon sources include, without limitation, carbon nanoribbons, graphene nanoribbons, functionalized graphene nanoribbons, graphene oxide nanoribbons, reduced graphene oxide nanoribbons, and combinations thereof.

In some embodiments, the carbon sources include graphene nanoribbons. In some embodiments, the carbon sources include functionalized graphene nanoribbons. In some embodiments, the functionalized graphene nanoribbons include, without limitation, edge-functionalized graphene nanoribbons, polymer-functionalized graphene nanoribbons, alkyl-functionalized graphene nanoribbons, and combinations thereof.

In some embodiments, the carbon sources include polymer-functionalized graphene nanoribbons. In some embodiments, the polymer-functionalized graphene nanoribbons are edge-functionalized. In some embodiments, the polymer-functionalized graphene nanoribbons are functionalized with polymers that include, without limitation, vinyl polymers, polyethylene, polystyrene, polyvinyl chloride, polyvinyl acetate, polyvinyl alcohol, polyacrylonitrile, and combinations thereof. In some embodiments, the polymer-functionalized graphene nanoribbons are functionalized with polyethylene oxide. In some embodiments, the polymer-functionalized graphene nanoribbons are functionalized with poly(ethylene oxides) (also known as poly(ethylene glycols)). In some embodiments, the polymer-functionalized graphene nanoribbons may include polyethylene oxide-functionalized graphene nanoribbons (PEO-GNRs).

In some embodiments, the carbon sources include alkyl-functionalized graphene nanoribbons. In some embodiments, the alkyl-functionalized graphene nanoribbons are functionalized with alkyl groups that include, without limitation, hexadecyl groups, octyl groups, butyl groups, and combinations thereof. In some embodiments, alkyl- functionalized graphene nanoribbons include hexadecylated-graphene nanoribbons (HD-GNRs).

In some embodiments, the carbon sources include graphene nanoribbons that are derived from carbon nanotubes. In some embodiments, the graphene nanoribbons may be substantially free of defects. In some embodiments, the graphene nanoribbons are non-oxidized. In some embodiments, the graphene nanoribbons have a flattened structure. In some embodiments, the graphene nanoribbons have a foliated structure.

In some embodiments, the graphene nanoribbons have a stacked structure. In some embodiments, the graphene nanoribbons include a single layer. In some embodiments, the graphene nanoribbons include a plurality of layers. In some embodiments, the graphene nanoribbons include from about 1 layer to about 100 layers. In some embodiments, the graphene nanoribbons include from about 20 layers to about 80 layers. In some embodiments, the graphene nanoribbons include from about 2 layers to about 50 layers. In some embodiments, the graphene nanoribbons include from about 2 layers to about 10 layers. In some embodiments, the graphene nanoribbons of the present disclosure include from about 1 layer to about 4 layers.

Graphene nanoribbons that are utilized as carbon sources may also have various sizes. For instance, in some embodiments, the graphene nanoribbons include widths ranging from about 100 nm to about 500 nm. In some embodiments, the graphene nanoribbons include widths ranging from about 200 nm to about 300 nm. In some embodiments, the graphene nanoribbons have thicknesses ranging from about 10 nm to about 100 nm. In some embodiments, the graphene nanoribbons have thicknesses ranging from about 25 nm to about 50 nm. In some embodiments, the graphene nanoribbons have thicknesses of about 40 nm.

Graphene Nanoribbon Fabrication

Graphene nanoribbons that are utilized as carbon sources may be derived from various sources. For instance, in some embodiments, graphene nanoribbons may be derived from carbon nanotubes, such as multi-walled carbon nanotubes. In some embodiments, the graphene nanoribbons are derived through the longitudinal splitting (or “unzipping”) of carbon nanotubes.

Various methods may be used to split (or “unzip”) carbon nanotubes to form graphene nanoribbons. In some embodiments, carbon nanotubes may be split by exposure to potassium, sodium, lithium, alloys thereof, metals thereof, salts thereof, and combinations thereof. For instance, in some embodiments, the splitting may occur by exposure of the carbon nanotubes to a mixture of sodium and potassium alloys, a mixture of potassium and naphthalene solutions, and combinations thereof. In some embodiments, the graphene nanoribbons of the present disclosure are made by the longitudinal splitting of carbon nanotubes using oxidizing agents (e.g., KMnO₄). In some embodiments, the graphene nanoribbons of the present disclosure are made by the longitudinal opening of carbon nanotubes (e.g., multi-walled carbon nanotubes) through in situ intercalation of Na/K alloys into the carbon nanotubes. In some embodiments, the intercalation may be followed by quenching with a functionalizing agent (e.g., 1-iodohexadecane) to result in the production of functionalized graphene nanoribbons (e.g., HD-GNRs).

Additional variations of such embodiments are described in U.S. Provisional Application No. 61/534,553 entitled “One Pot Synthesis of Functionalized Graphene Oxide and Polymer/Graphene Oxide Nanocomposites.” Also see PCT/US2012/055414, entitled “Solvent-Based Methods For Production Of Graphene Nanoribbons.” Also see Higginbotham et al., “Low-Defect Graphene Oxide Oxides from Multiwalled Carbon Nanotubes,” ACS Nano 2010, 4, 2059-2069. Also see Applicants' co-pending U.S. patent application Ser. No. 12/544,057 entitled “Methods for Preparation of Graphene Oxides From Carbon Nanotubes and Compositions, Thin Composites and Devices Derived Therefrom.” Also see Kosynkin et al., “Highly Conductive Graphene Oxides by Longitudinal Splitting of Carbon Nanotubes Using Potassium Vapor,” ACS Nano 2011, 5, 968-974. Also see WO 2010/14786A1.

Dopants

The catalysts of the present disclosure may be associated with various types of dopants. For instance, in some embodiments, the dopants include, without limitation, boron, nitrogen, sulfur, phosphorus, and combinations thereof.

In some embodiments, the dopant is a heteroatom. In some embodiments, the dopant is a heteroatom that includes boron and nitrogen. In some embodiments, the dopant is hexagonal boron nitride (h-BN).

The catalysts of the present disclosure may have various amounts of dopant. For instance, in some embodiments, the catalysts of the present disclosure have a total dopant content of about 2 wt % to about 30 wt %. In some embodiments, the catalysts of the present disclosure have a total dopant content of about 5 wt % to about 25 wt %. In some embodiments, the catalysts of the present disclosure have a total dopant content of about 10 wt %.

In some embodiments, the catalysts of the present disclosure have a combined boron and nitrogen content that ranges from about 2 wt % to about 30 wt %. In some embodiments, the catalysts of the present disclosure have a combined boron and nitrogen content that ranges from about 5 wt % to about 25 wt %. In some embodiments, the catalysts of the present disclosure have a combined boron and nitrogen content of about 10 wt %. In some embodiments, the catalysts of the present disclosure have a boron content that ranges from about 1 wt % to about 15 wt %. In some embodiments, the catalysts of the present disclosure have a nitrogen content that ranges from about 1 wt % to about 15 wt %.

Association of Dopants with Carbon Sources

The carbon sources in the catalysts of the present disclosure may be associated with dopants in various manners. For instance, in some embodiments, the carbon sources become associated with dopants by covalent bonds, non-covalent bonds, ionic bonds, chemisorption, physisorption, dipole interactions, van der Waals forces, and combinations thereof. In some embodiments, the dopant is covalently associated with the carbon source. In some embodiments, the dopant is non-covalently associated with the carbon source. In some embodiments, the dopant is covalently associated with edges of the carbon source. In some embodiments, the dopant is homogenously distributed throughout the carbon source.

Catalyst Shapes

The catalysts of the present disclosure can have various shapes and structures. For instance, in some embodiments, the catalysts of the present disclosure have a three-dimensional structure. In some embodiments, the individual carbon sources in the catalysts of the present disclosure are connected to each other through covalent or non-covalent bonds. In some embodiments, the individual carbon sources in the catalysts of the present disclosure are cross-linked to each other. In some embodiments, the carbon sources in the catalysts of the present disclosure have a network structure. In some embodiments, the carbon sources in the catalysts of the present disclosure are in the form of a lattice. In some embodiments, the carbon sources in the catalysts of the present disclosure are in the form of a gel, such as a hydrogel or an aerogel.

In some embodiments, the catalysts of the present disclosure may have a multi-layered structure. For instance, in some embodiments, the catalysts of the present disclosure have a plurality of layers. In some embodiments, the catalysts of the present disclosure have from about 2 layers to about 10 layers.

In some embodiments, the catalysts of the present disclosure have a porous structure with a plurality of pores. In some embodiments, the pores in the catalysts include diameters between about 1 nanometer to about 5 micrometers. In some embodiments, the pores include macropores with diameters of at least about 50 nm. In some embodiments, the pores include macropores with diameters between about 50 nanometers to about 3 micrometers. In some embodiments, the pores include macropores with diameters between about 500 nanometers to about 2 micrometers. In some embodiments, the pores include mesopores with diameters of less than about 50 nm. In some embodiments, the pores include micropores with diameters of less than about 2 nm.

In some embodiments, the pores in the catalysts of the present disclosure include diameters that range from about 1 nm to about 150 nm. In some embodiments, the pores include diameters that range from about 5 nm to about 100 nm. In some embodiments, the pores include diameters that range from about 2 nm to about 110 nm. In some embodiments, the pores include diameters that range from about 1 nm to about 10 nm. In some embodiments, the pores include diameters that range from about 1 nm to about 3 nm.

The catalysts of the present disclosure may also have various densities. For instance, in some embodiments, the catalysts of the present disclosure have densities that range from about 1 mg/cm³ to about 100 mg/cm³. In some embodiments, the catalysts of the present disclosure have densities that range from about 1 mg/cm³ to about 50 mg/cm³. In some embodiments, the catalysts of the present disclosure have densities that range from about 1 mg/cm³ to about 10 mg/cm³. In some embodiments, the catalysts of the present disclosure have densities of about 10 mg/cm³.

The catalysts of the present disclosure may also have various surface areas. For instance, in some embodiments, the catalysts of the present disclosure have surface areas that range from about 100 m²/g to about 5,000 m²/g. In some embodiments, the catalysts of the present disclosure have surface areas that range from about 100 m²/g to about 1,000 m²/g. In some embodiments, the catalysts of the present disclosure have surface areas that range from about 200 m²/g to about 900 m²/g. In some embodiments, the catalysts of the present disclosure have surface areas of about 200 m²/g. In some embodiments, the catalysts of the present disclosure have surface areas of about 900 m²/g.

The catalysts of the present disclosure may also have various widths and lengths. For instance, in some embodiments, the catalysts of the present disclosure have widths that range from about 1 nm to about 200 nm. In some embodiments, the catalysts of the present disclosure have widths that range from about 1 nm to about 100 nm. In some embodiments, the catalysts of the present disclosure have widths that range from about 10 nm to about 80 nm.

In some embodiments, the catalysts of the present disclosure have lengths that range from about 1 mm to about 200 mm. In some embodiments, the catalysts of the present disclosure have lengths that range from about 1 nm to about 100 nm. In some embodiments, the catalysts of the present disclosure have lengths that range from about 10 nm to about 80 nm.

Electrocatalytic Performance

The catalysts of the present disclosure may have various electrocatalytic properties. For instance, in some embodiments, the catalysts of the present disclosure have an onset-potential of more than about 0.95 V. In some embodiments, the catalysts of the present disclosure have an onset-potential of more than about 1 V. In some embodiments, the catalysts of the present disclosure have an onset-potential of more than about 1.1 V.

In some embodiments, the catalysts of the present disclosure have an electron transfer number between about 1 and 4. In some embodiments, the catalysts of the present disclosure have an electron transfer number between about 3 and 4. In some embodiments, the catalysts of the present disclosure have an electron transfer number of about 4.

In some embodiments, the catalysts of the present disclosure have a half-wave potential between about −2 and 1. In some embodiments, the catalysts of the present disclosure have a half-wave potential between about −1.5 and 0.5. In some embodiments, the catalysts of the present disclosure have a half-wave potential between about −1.2 and 0.4.

In some embodiments, the catalysts of the present disclosure have a kinetic current density between about 1 mA/cm² and about 100 mA/cm². In some embodiments, the catalysts of the present disclosure have a kinetic current density between about 5 mA/cm² and about 10 mA/cm². In some embodiments, the catalysts of the present disclosure have a kinetic current density of about 7 mA/cm².

In some embodiments, the electrocatalytic performances of the catalysts of the present disclosure are adjustable as a function of dopant concentration. For instance, in some embodiments, higher dopant concentrations enhance the electrocatalytic performance of the catalysts of the present disclosure.

Association of Catalysts with Devices and Environments

The catalysts of the present disclosure may be associated with various devices and environments. For instance, in some embodiments, the catalysts of the present disclosure are associated with an energy conversion device. In some embodiments, the energy conversion device is a fuel cell. In some embodiments, the energy conversion device is a battery, such as a metal-air battery (e.g., zinc-air battery) or a lithium-ion battery. In some embodiments, the catalysts of the present disclosure are associated with an electrically conductive surface that generates electrical current. In some embodiments, the electrically conductive surface is an electrode, such as a cathode or an anode.

Methods of Making Catalysts

Additional embodiments of the present disclosure pertain to methods of making the catalysts of the present disclosure. In some embodiments illustrated in FIG. 1B, such methods include assembling a carbon source into a three-dimensional structure (step 30) and doping the carbon source with a dopant (step 32). In some embodiments, the methods of the present disclosure also include a step of reducing the carbon source (step 34). As set forth in more detail herein, various methods may be utilized to carry out the aforementioned steps.

Assembly of Carbon Sources into Three-Dimensional Structures

Various methods may be utilized to assemble carbon sources into three-dimensional structures. For instance, in some embodiments, carbon sources are assembled into a three-dimensional structure through hydrothermal treatment of the carbon source. In some embodiments, the hydrothermal treatment of the carbon sources involves treating the carbon source with water under pressure in a container (e.g., a sealed vessel) at temperatures above 100° C. (e.g., temperatures of about 180° C. to 220° C.).

In some embodiments, the carbon sources are assembled into a three-dimensional structure through cross-linking of the carbon sources. In some embodiments, carbon sources are assembled into a three-dimensional structure through sonication. In some embodiments, carbon sources are assembled into a three-dimensional structure through freeze-drying.

As set forth previously, various carbon sources may be utilized in the methods of the present disclosure. For instance, in some embodiments, the carbon sources may include carbon nanoribbons. In some embodiments, the carbon sources may include graphene nanoribbons. In some embodiments, the methods of the present disclosure may also include a step of forming the graphene nanoribbons. In some embodiments, the graphene nanoribbons are formed by the longitudinal splitting of carbon nanotubes (as described previously). In some embodiments, the longitudinal splitting of carbon nanotubes occurs by exposure of the carbon nanotubes to at least one of potassium, sodium, lithium, alloys thereof, metals thereof, salts thereof, and combinations thereof. In some embodiments, the longitudinal splitting of carbon nanotubes occurs by exposure of the carbon nanotubes to an oxidizing agent, such as potassium permanganate or sodium perchlorate.

Doping

As set forth previously, the carbon sources of the present disclosure may be doped with various dopants. In addition, various methods may be utilized to dope carbon sources with one or more dopants.

For instance, in some embodiments, the doping includes associating a carbon source with dopant precursors. In some embodiments, the dopant precursors may be in gaseous form. In some embodiments, the dopant precursors may be in liquid form or solid form.

In some embodiments, carbon sources are associated with dopant precursors by annealing. In some embodiments, the annealing occurs at or above 1,000° C. In some embodiments, the dopant precursor is boric acid. In some embodiments, the boric acid serves as a boron doping source. In some embodiments, the dopant precursor is ammonia. In some embodiments, the ammonia serves as a nitrogen doping source.

In some embodiments, the methods of the present disclosure also include a step of controlling dopant level by adjusting doping time. For instance, in some embodiments, reaction times can be adjusted from 15 minutes to 1 hour in order to control the dopant levels in the formed catalysts.

Carbon Source Reduction

In some embodiments, the methods of the present disclosure also include a step of reducing the carbon source. In some embodiments, carbon source reduction can occur by exposure of the carbon source to one or more reducing agents. In some embodiments, the reducing agent can include, without limitation, H₂, NaBH₄, hydrazine, and combinations thereof. In some embodiments, the reducing agent includes H₂.

Advantages

The methods and catalysts of the present disclosure provide enhanced ORR activity, especially when compared to methods and catalysts that utilize conventional catalysts (e.g., Pt/C). Furthermore, the catalysts of the present disclosure are much less expensive than the noble metal catalysts, such as Pt. Moreover, the catalysts of the present disclosure can provide long-term durability. For instance, in some embodiments, the ORR electrocatalytic activities of the catalysts of the present disclosure are not affected after multiple cycles (e.g., up to 5,000 continuous cycles).

Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Boron- and Nitrogen-Substituted Graphene Nanoribbons as Efficient Catalysts for Oxygen Reduction Reaction

In this Example, Applicants demonstrate the development of an efficient approach to construct three-dimensional (3D) architectures from numerous edge-abundant boron- and nitrogen-substituted carbon nanoribbons (hitherto termed BNC NR) for oxygen reduction reaction (ORR) electrocatalysts. The typical synthesis approach involves the use of oxidized graphene oxide nanoribbons (GONR) as building blocks to construct 3D architectures and subsequent employment of boric acid and ammonia as boron and nitrogen doping sources. The resulting 3D BNC NR possess abundant edges, thin walls, tunable BN content and multilevel porous structures. Such unique features not only provide a large amount of active sites for ORR, but are also favorable for the fast transport of oxygen and reduction products. As a consequence, BNC architectures with BN content of ˜10 wt % exhibit optimal ORR electrocatalytic properties, including high electrocatalytic activity, long-term durability and high selectivity. Remarkably, this catalyst possesses the highest onset and half-wave potentials for ORR in alkaline media of any reported metal-free catalyst, and even outperforms the most active Pt-C catalyst.

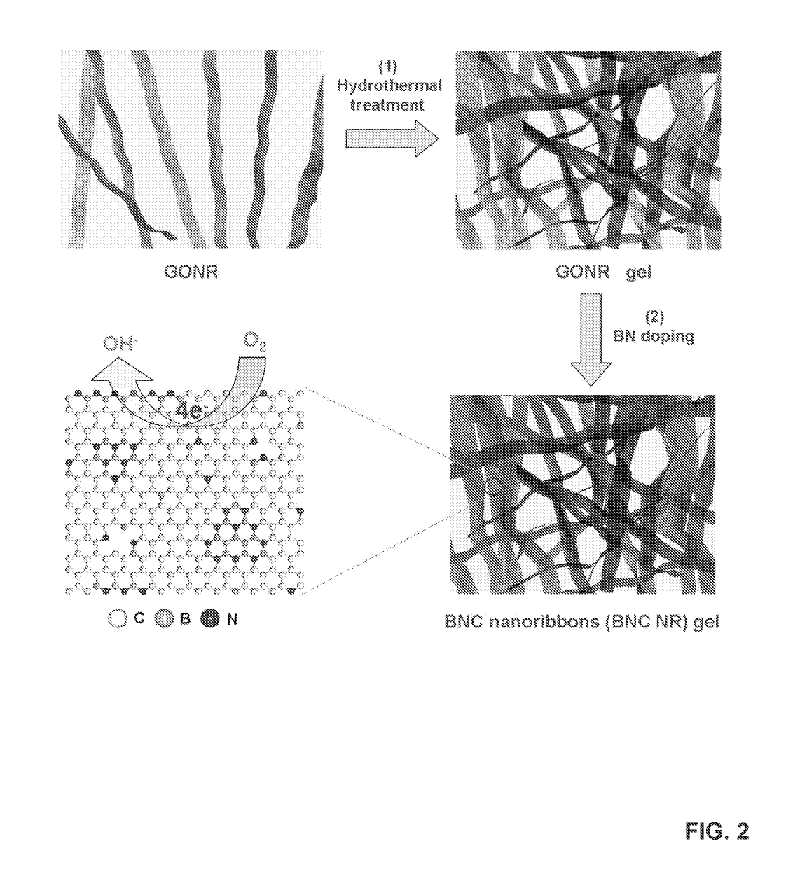

As illustrated in FIG. 2, the synthetic procedure to 3D BNC NR involves three steps. First, water-dispersible GONR was synthesized by unzipping multi-walled carbon nanotubes under oxidative conditions. The as-prepared GONR was then used as a building block to construct 3D GONR architectures via a cross-linking reaction at 180° C. in an autoclave (similar to the formation of 3D graphene oxide hydrogels). Some reduction of the GONRs takes place during the hydrothermal reaction. After freeze-drying, the samples were annealed with boric acid and ammonia at 1000° C., where GONR was thermally reduced to graphene nanoribbons (GNRs). At the same time, boron and nitrogen were co-doped into the GNRs, thereby creating 3D BNC NRs (See Examples 1.1-1.3 for details).

Notably, the BN content in the resulting materials was controllably adjusted from 5.9 w % to 24.2 wt %. Table 1 lists the detailed composition of each sample.

TABLE 1
The concentration of boron, nitrogen and
carbon in different BNC NR samples.

| Material (at %) | BNC-1 | BNC-2 | BNC-3 | BNC-4 |
|---|---|---|---|---|
| Carbon | 94.1 | 90.3 | 83.6 | 75.8 |
| Boron | 2.8 | 4.7 | 8.1 | 11.9 |
| Nitrogen | 3.1 | 5.0 | 8.3 | 12.3 |

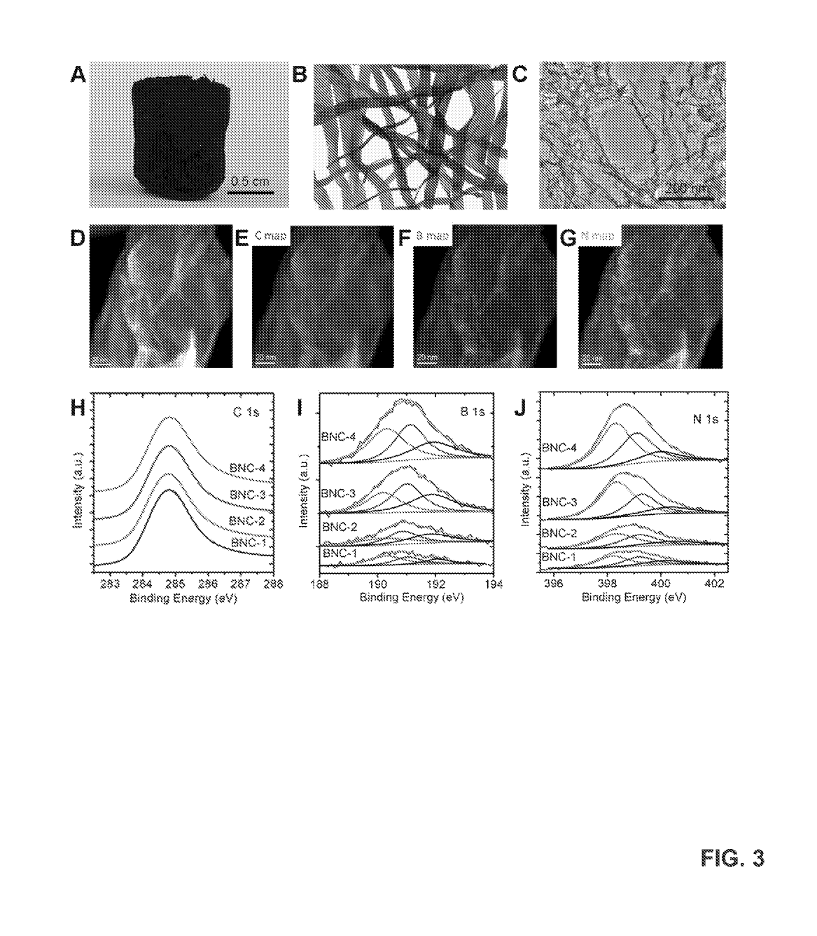

BNC-1, BNC-2, BNC-3 and BNC-4 correspond to annealing times of 15 minutes, 30 minutes, 45 minutes and 1 hour, respectively. The oxygen percent is very low and ignored here. The BNC NR products can be produced in large volume with low volume densities of ˜10 mg/cm³ (FIG. 3A).

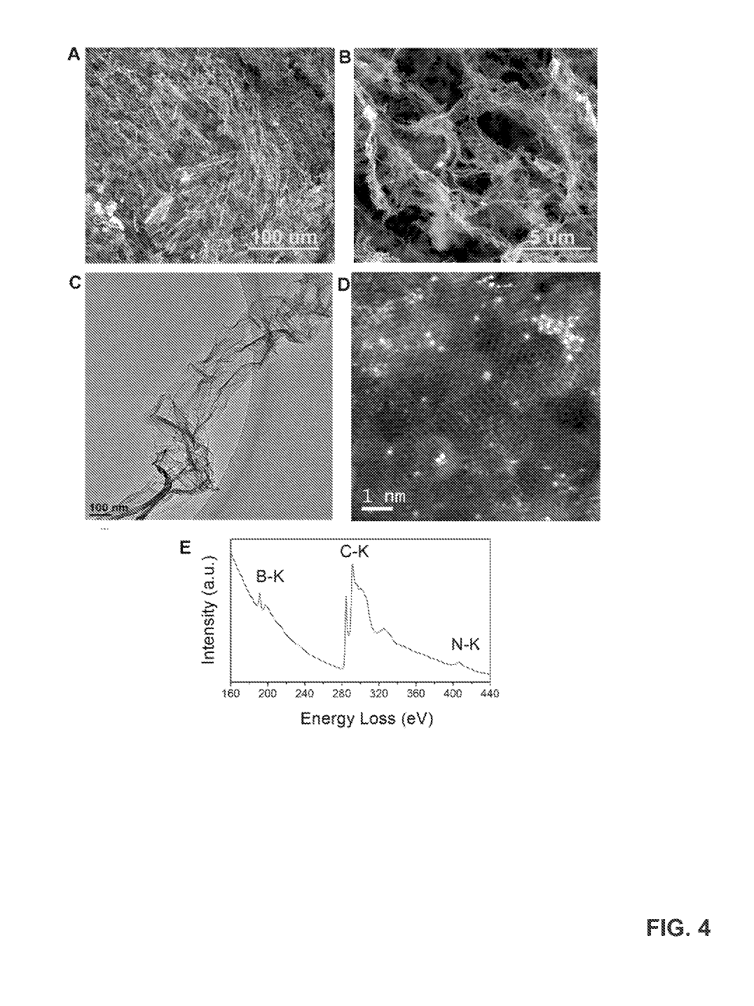

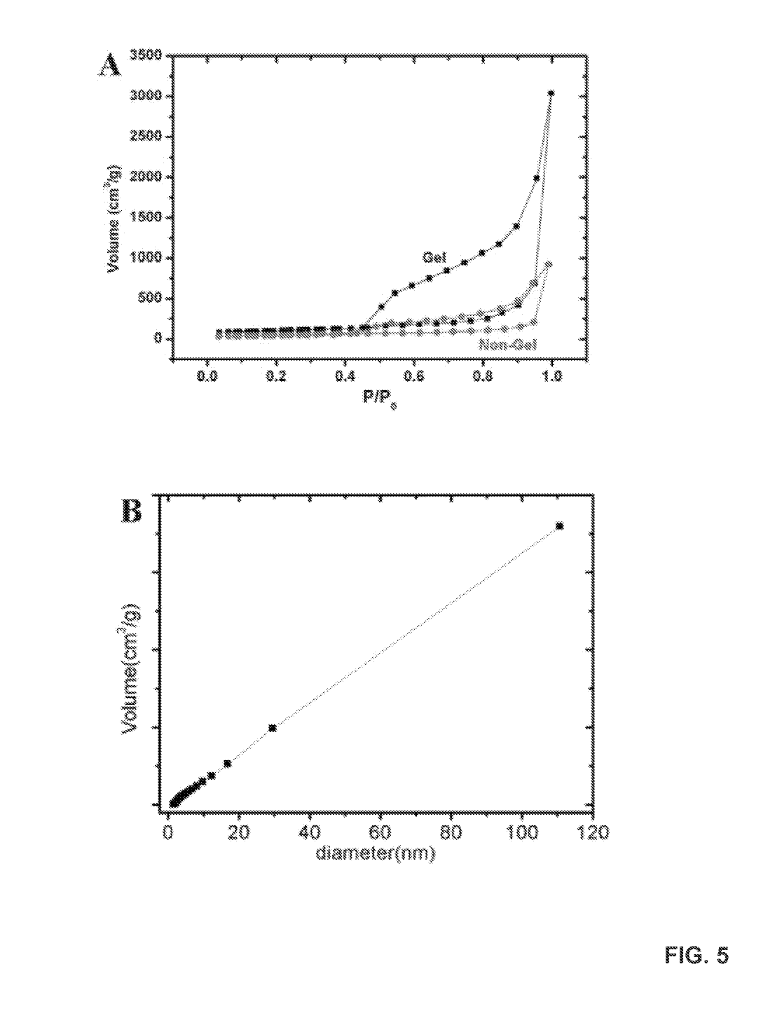

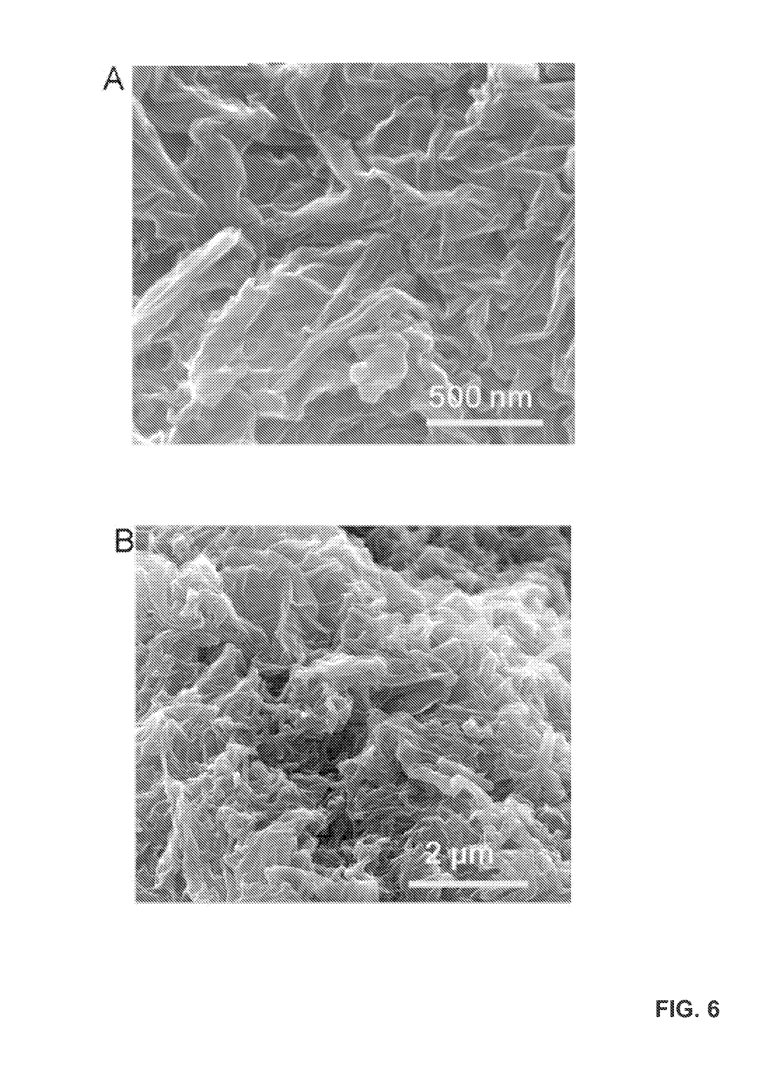

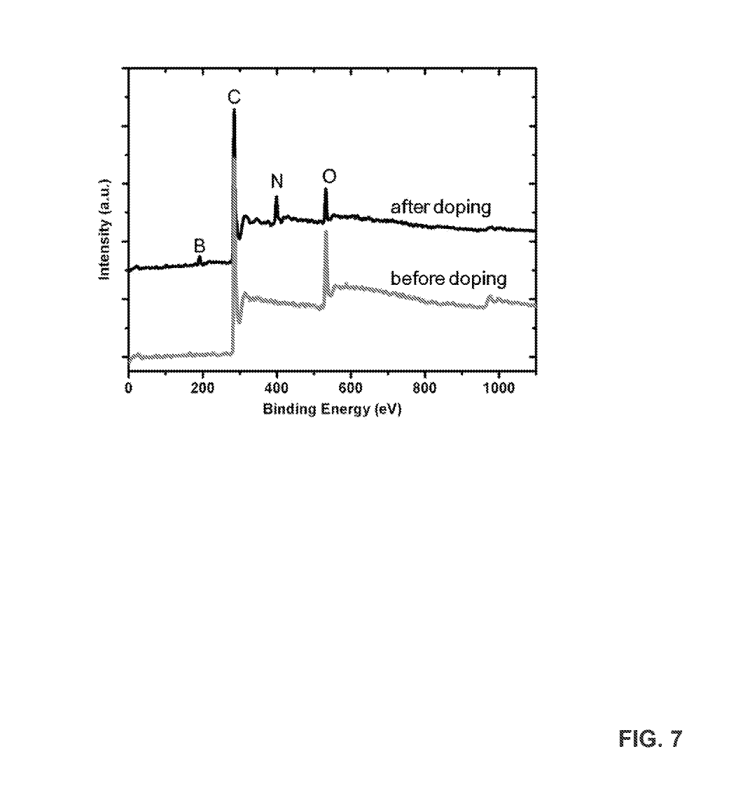

The structure and morphology of as-prepared BNC NR were investigated by scanning electron microscopy (SEM) and transmission electron microscopy (TEM). As shown in FIGS. 3C and 4, the 3D interpenetrating networks built from numerous flexible ribbons are clearly visible. The lateral sizes of the building block ribbons are typically in the range of tens of nanometers in width and several tens of micrometers in length (FIG. 3C). Their adsorption-desorption isotherms exhibit a typical IV hysteresis loop at a relative pressure between 0.4 and 1.0 (FIG. 5), characteristic of pores with different pore diameters. In a typical case of BNC NR with ˜10 wt % BN doping content, a high specific surface area of 875 m²/g is observed from the adsorption data. This value is much higher than that of the directly dried GONR powder (201 m²/g) (FIGS. 5-6), further demonstrating that the controllable assembly strategy is an efficient protocol to prevent the re-stacking of GNRs. FIGS. 3D-G show a typical scanning transmission electron microscopy (STEM) annular dark field (ADF) image and elemental mapping of BNC NR with ˜10 wt % BN, where all the elements (B, C, and N) are homogenously distributed throughout the whole NR. The electron energy loss spectroscopy (EELS) (FIG. 4E) and X-ray photoelectron spectroscopy (XPS) (FIG. 7) analysis further show that only carbon, boron, nitrogen and oxygen are present in the BNC NR, and the BN content can be tailored by controlling the duration of the annealing process under boron and nitrogen environment (Table 1).

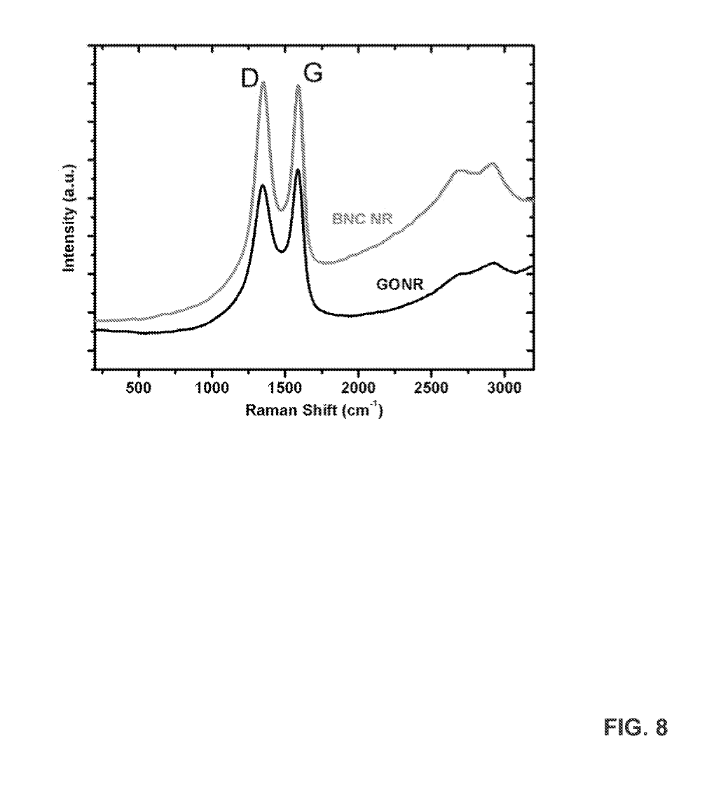

The complex B1s spectra can be further deconvoluted into three different components with binding energies of 190.3, 191.1, and 191.9 eV, attributed to BNC₂, BN₂C and BN₃, respectively. Correspondingly, the N1s spectra can be fitted with three peaks at 398.3, 399.1 and 400.0 eV, ascribed to NB₃, NB₂C and NBC₂, respectively. Upon increasing the annealing time from 15 minutes to 1 hour, the signals for BN₃ and NB₃ significantly increase, suggesting the aggregation of BN pairs into BN domains at high BN concentration. In addition, the substitutional doping is supported by the increase of the D peak in the Raman spectra from the converted BNC NR (FIG. 8).

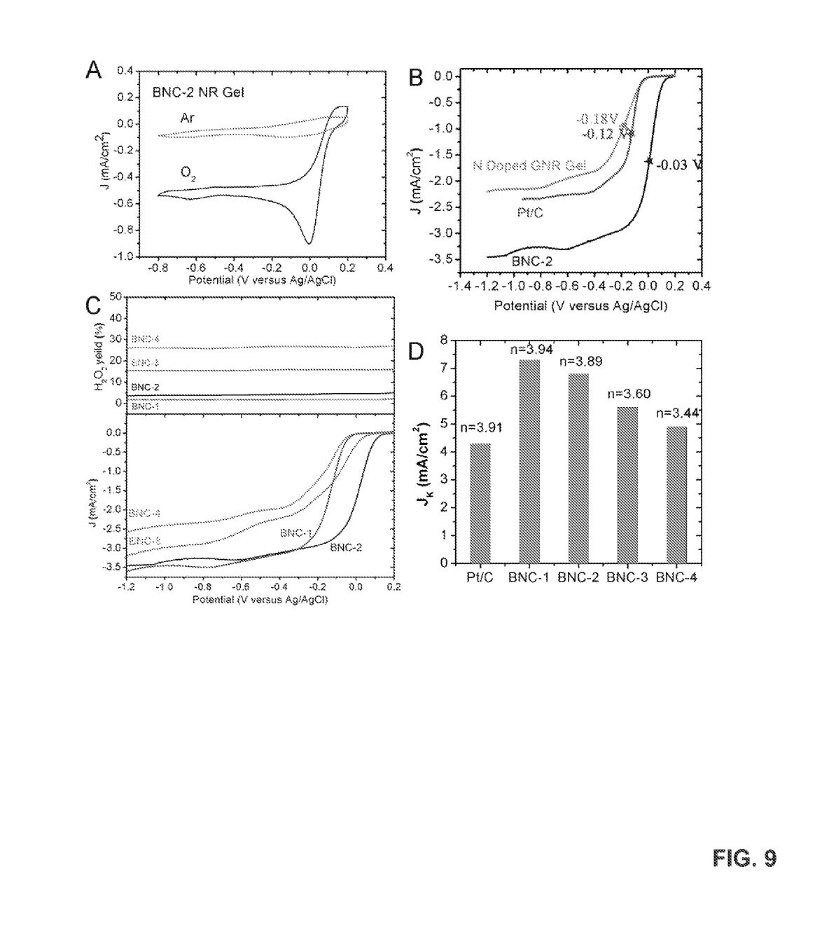

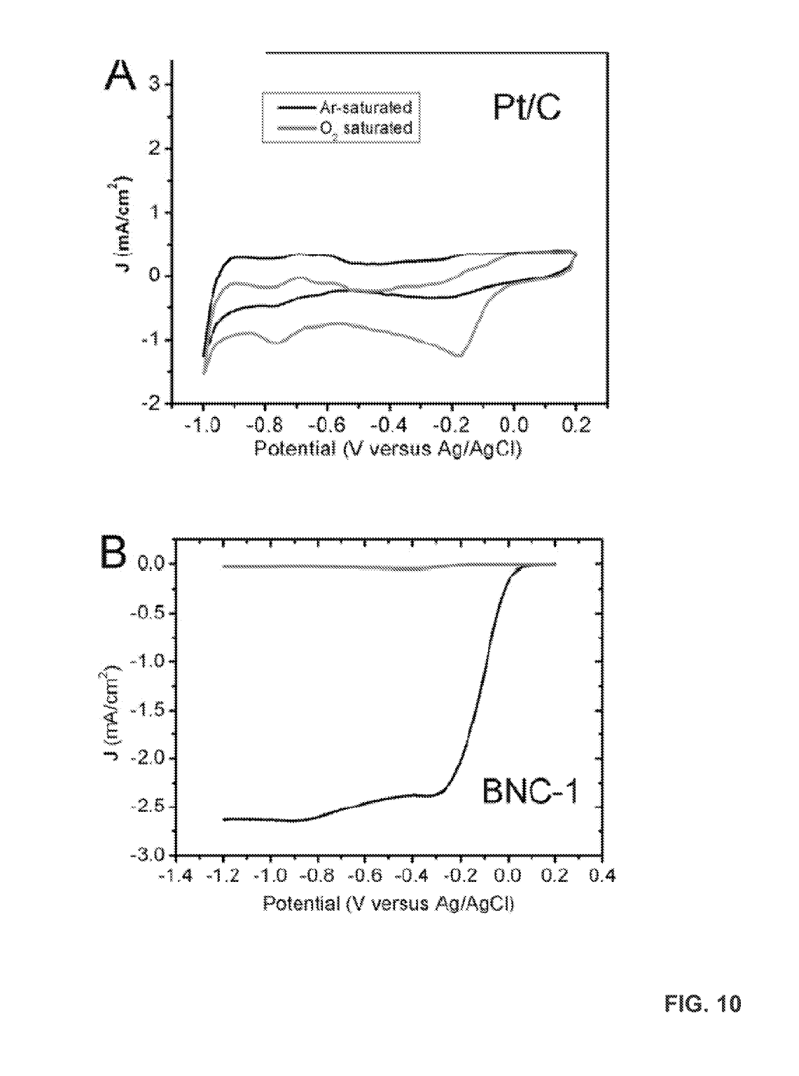

The electrocatalytic activity of BNC NR for ORR was initially examined by cyclic voltammetry (CV) in the potential range from 0.2 to -1.0 V vs. Ag/AgCl at a scan rate of 100 mV/s. As shown in FIG. 9A, in the Ar-saturated 0.1 M KOH solution, a featureless voltammogram without any evident peak is observed. In contrast, as the KOH solution is saturated with O₂, a well-defined and strong cathodic peak occurs at about 0 V, indicating the high catalytic activities of BNC NR for ORR. More importantly, this cathodic peak is even more positive than that of commercially available Pt/C catalyst (−0.2 V) (FIG. 10A).

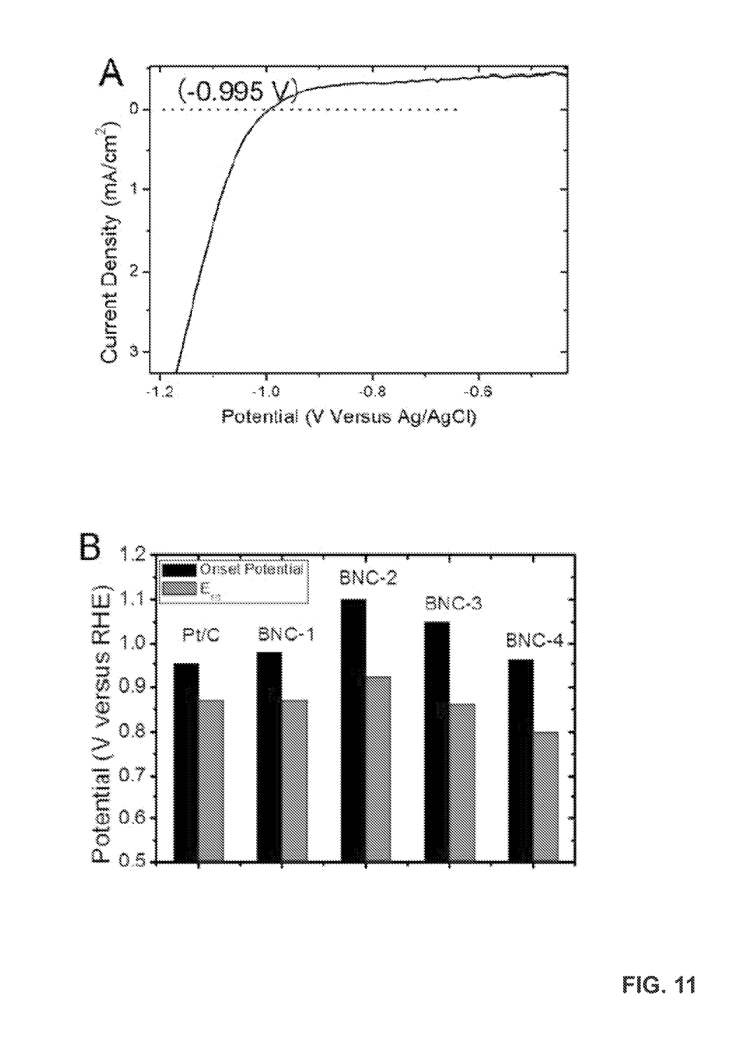

To gain further insights into the ORR activity of BNC NR, rotating ring disk electrode (RRDE) voltammetry was performed in an O₂-saturated 0.1 M KOH solution at a scanning rate of 10 mV/s (FIGS. 9B-C and 10B). The electrocatalytic properties, including the onset potential, half-wave potential, saturated current density and electron transfer number are strongly dependent on B and N doping concentrations in BNC NR. As shown in FIGS. 9C and 11, with an increase of the doping level from 5.9 wt % to 24.2 wt %, the onset potential first increases and then decreases with the highest value of 0.1 V vs. Ag/AgCl (1.09 V vs. RHE, FIG. 11A) for BNC-2 with ˜10 wt % BN content. More remarkably, the half-wave potential of BNC-2 is only −0.03 V vs. Ag/AgCl (0.96 V vs. RHE) (FIG. 9B), which is higher than any reported metal-free catalyst in alkaline media (0.4 to 0.8 V vs. RHE) and even higher than commercial Pt-C catalysts (0.87 V vs. RHE in this study).

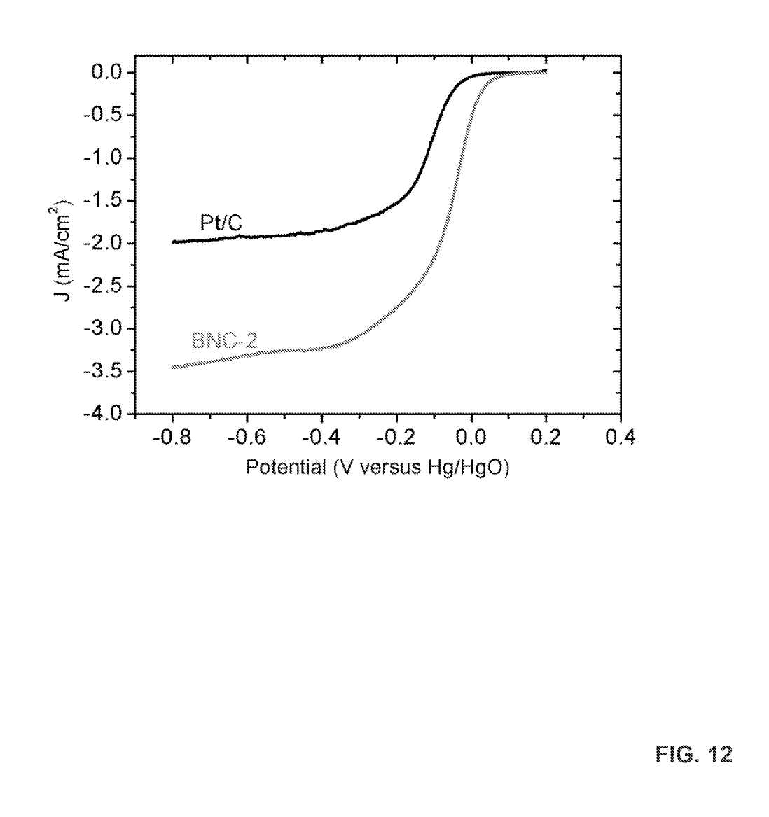

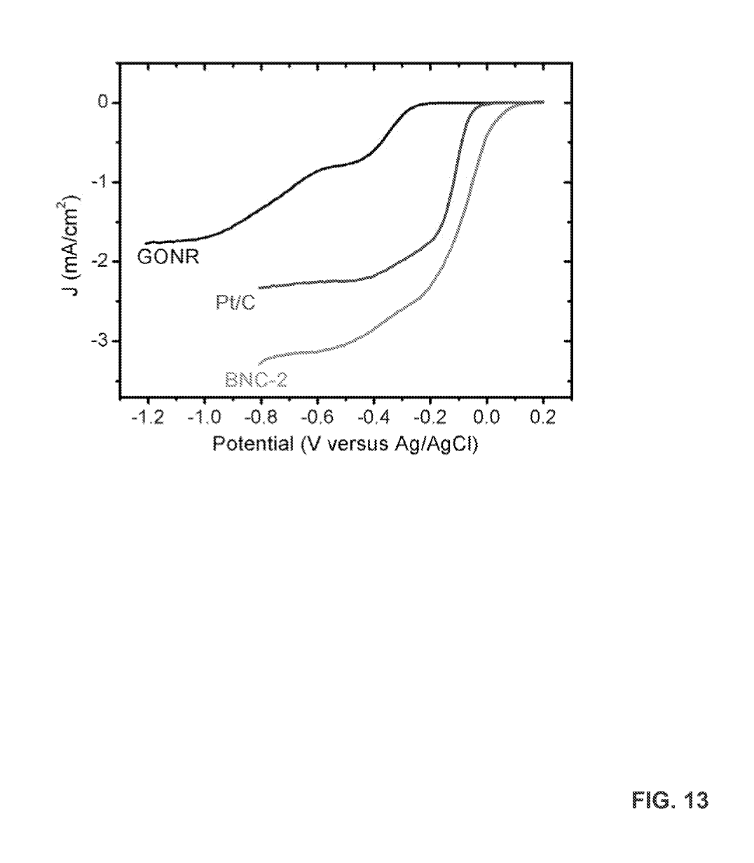

To avoid any problems caused by using Ag/AgCl reference in alkaline solution (chloride contamination), Hg/HgO reference was also used to test the RRDE voltammetry curves of BNC-2 and commercial Pt-C catalysts (FIG. 12). Based on above data, BNC-2 has much better electrocatalytic performance than N-doped GNRs, as well as the un-doped GNRs (FIG. 13). Without being bound by theory, it is envisioned that such high onset potential and half-wave potential could give rise to a very low overpotential.

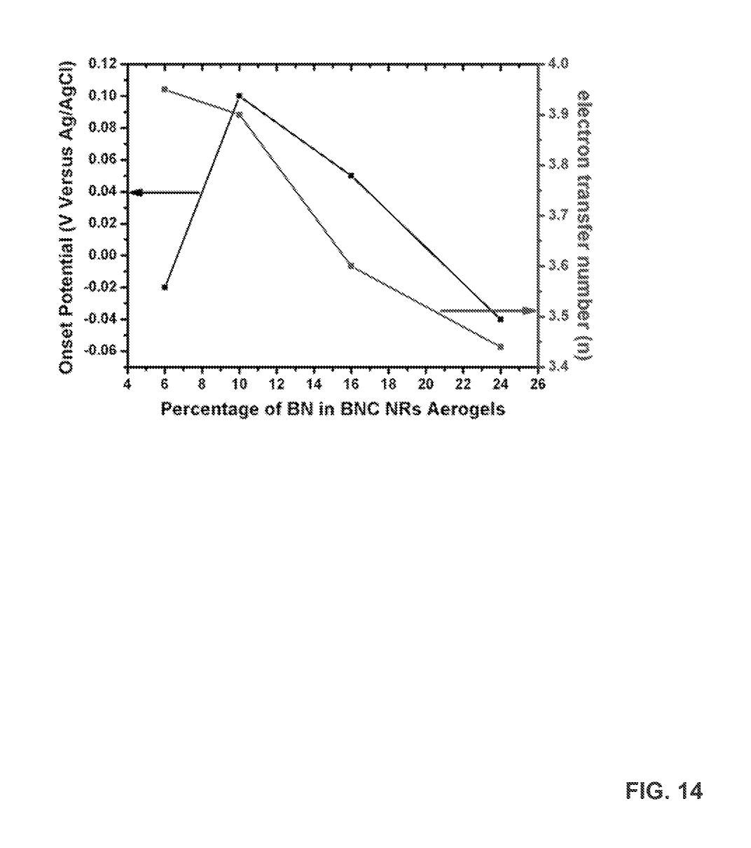

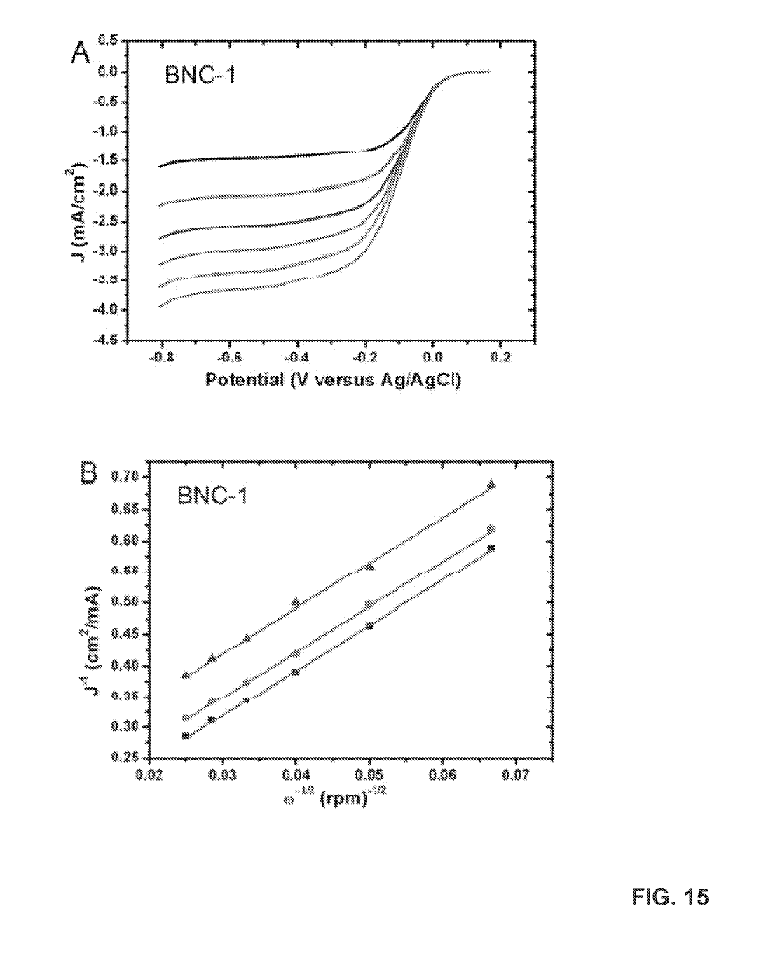

From the RRDE voltammograms, the production of peroxide species (HO₂⁻) during the ORR process can also be identified. The HO₂⁻ yields are less than 5% for the BNC NR with BN content ranging from 6 wt % to 10 wt % (FIG. 9C and 14). This value is close to that of commercial Pt-C catalysts (4 to 5%), suggesting that these BNC NR exhibit mainly one-step, four-electron transfer pathways for ORR. The kinetic parameters, including electron transfer number (n) and kinetic current density (J_{K}) of the resulting BNC NR (FIG. 9D) were further analyzed on the basis of the Koutecky-Levich equations (FIG. 15) and Equation 1:

n=4I_{D}/(I_{D}+I_{R}/N) (1)

In Equation 1, N=0.36 is the current collection efficiency, I_{D} is the disk current, and I_{R} is the ring current. An electron transfer number of ˜3.9 is achieved for the BNC NR with the BN content ranging from 5.9 wt % to 9.7 wt %, in good agreement with the above analysis. However, with the increase of BN content from 16.4 wt % to 24.2 wt %, the electron transfer number of the BNC NR is reduced from 3.6 to 3.2, involving mixed two-electron and four-electron transfer pathways during the ORR process. Without being bound by theory, it is envisioned that the decrease of the electron transfer number can be attributed to the reduction of the conductivity of the BNC NRs with increased BN content, which in turn can obstruct electron transfer.

The kinetic current density of BNC NR is also strongly governed by the BN content. Typically, the highest kinetic current density of 7.2 mA/cm² is observed for BNC-1. This value is much higher than that of commercial Pt/C (J_{K}=4.3 mA/cm²) under the same testing conditions. Overall, the catalytic activity increases at the beginning and then decreases with increase of BN content, which can be explained by the change of active catalytic sites and electrical conductivity of the BNC NR. At the beginning, increasing the BN concentration (<10%) results in more active catalytic sites, leading the improvement of their catalytic activity. However, further increasing the doping concentration (>10%) would undermine the conductivity of BNC, which would weaken the charge transport from electrode to oxygen.

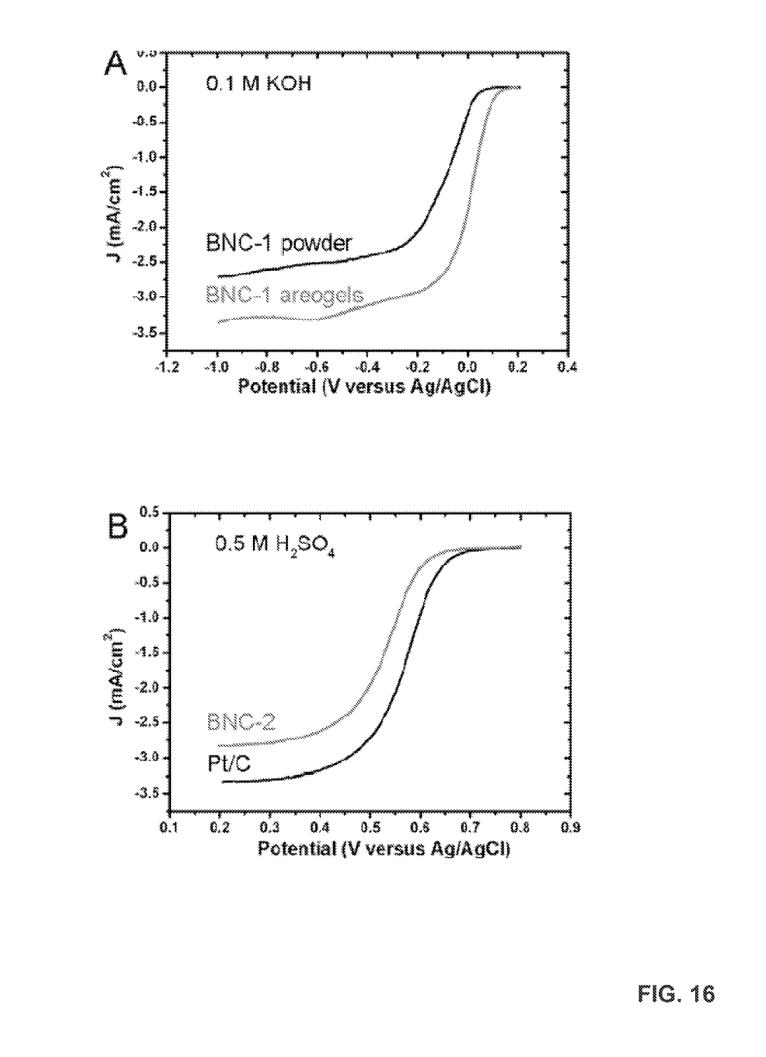

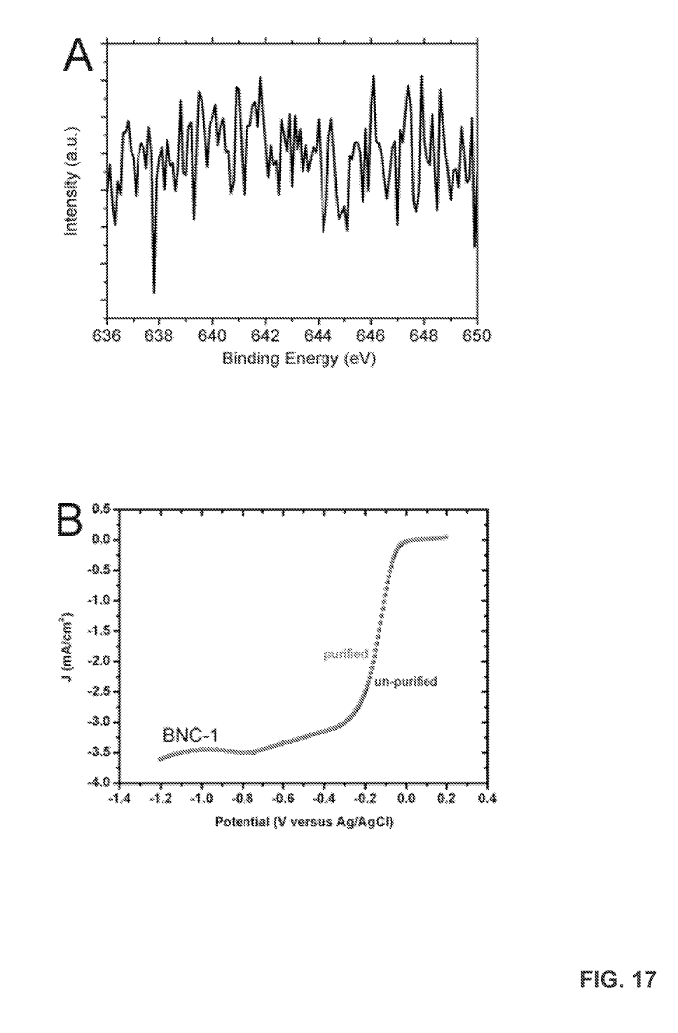

Applicants also tested the ORR performance of the BNC samples (FIG. 16B) in acidic conditions (0.5 M H₂SO₄). Although it is not as good as in base, the best performance of BNC (BNC-2) is still very close to the performance of Pt/C. To remove the concern of the possible rudimental Mn ions from the fabrication of GONR or any other rudimental metal elements from the growth of carbon nanotubes, detailed XPS measurement and purification was performed. As shown in FIG. 17A, a precise sweep around 645 eV clearly reveals the absence of Mn element. Applicants further treated BNC samples with acid, which could efficiently remove the rudimental metal ions. However, in this case, Applicants found there is almost no difference before and after purification (FIG. 17B), proving no rudimental ions or no effect of rudimental ions to the ORR performance.

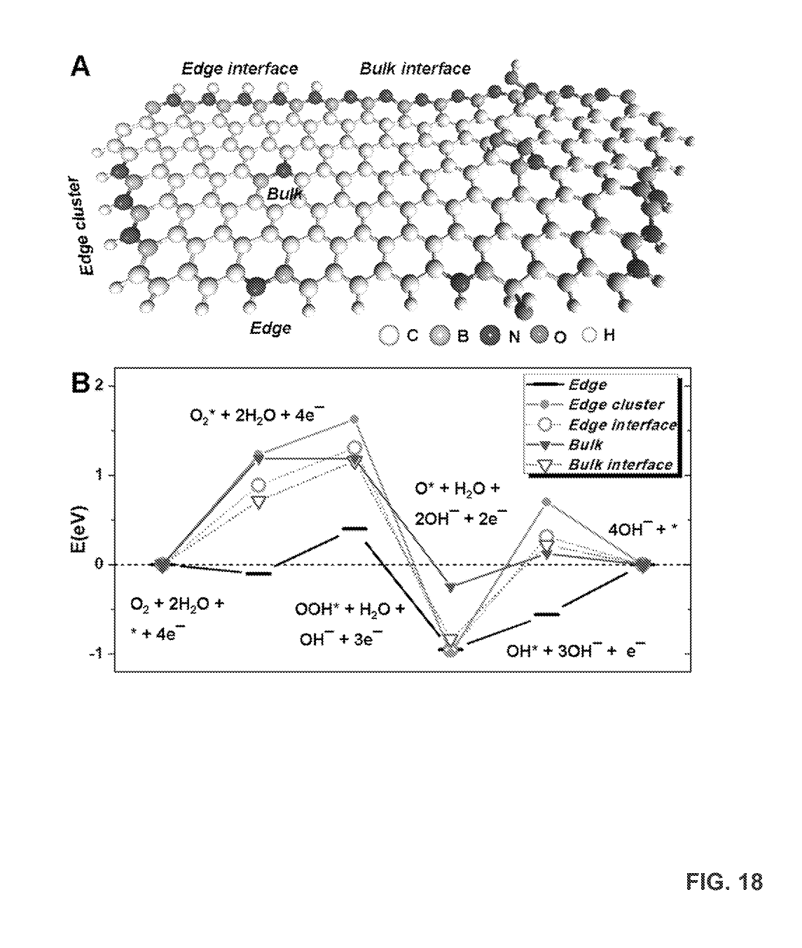

To further shed light on the ORR catalytic behaviors of BNC NR with various BN contents, spin-polarized density functional theory (DFT) calculations were performed using the Vienna ab-initio Simulation Package (VASP). Physical Review B, 1996, 54, 11169-11186. Five configurations, (i) one BN pair in the middle of a graphene sheet (Bulk), (ii) one BN pair at the edge (Edge), (iii) three BN pairs at the edge (Edge cluster), (iv) a line of BN pairs at the nanoribbon edges (Edge interface), and (v) interface between BN and graphene domains (Bulk interface), representing different doping concentrations, are shown in FIG. 18A. As proposed by Bao et al., it is envisioned that O₂ reduction in alkaline solution follows the associative rather than the dissociative mechanism. J. Catal., 2011, 282, 183-190.

The free energy diagrams (FIG. 18B) show that, in the case of Bulk doping, the highest energy barrier is 1.18 eV for O₂ adsorption, which is identified as the rate-determining step. In sharp contrast with the introduction of one BN pair at the GNR edges (Edge), the O₂ adsorption becomes energetically favorable. With further increasing the BN doping level, h-BN domains tend to nucleate and grow in the GNRs, forming finite Edge cluster, Edge interface, or Bulk interface. For Edge cluster, Applicants consider the active C site bonding to the middle B site to make a difference.

Simulations demonstrate that not only the binding of O₂ for all these three cases remains a steep uphill process, but also the barriers for proton transfer to adsorbed O are larger than 1 eV, indicating weak OH binding relative to the strong O binding. For the Edge case, the binding between the OH and edge C next to B atom, where the π bonding in graphene is partially broken, renders the bond hybridization of the C atom changing from sp² to sp³ (bottom right in FIG. 18A). This makes the energy for OH adsorption and the barrier for the O protonation decrease significantly. Thus, the decreased number of such edge C sites, the increased barriers for the two rate-determining steps at the interfaces, and the reduced electrical conductivity clearly explain the above electrocatalytic activity change as doping concentration varies from 5.9 wt % to 24.2 wt %. Further analyses show that the spin polarization of the edge C atoms near active B sites plays a key role in the enhancement of the binding of O₂ (See Examples 1.4-1.7).

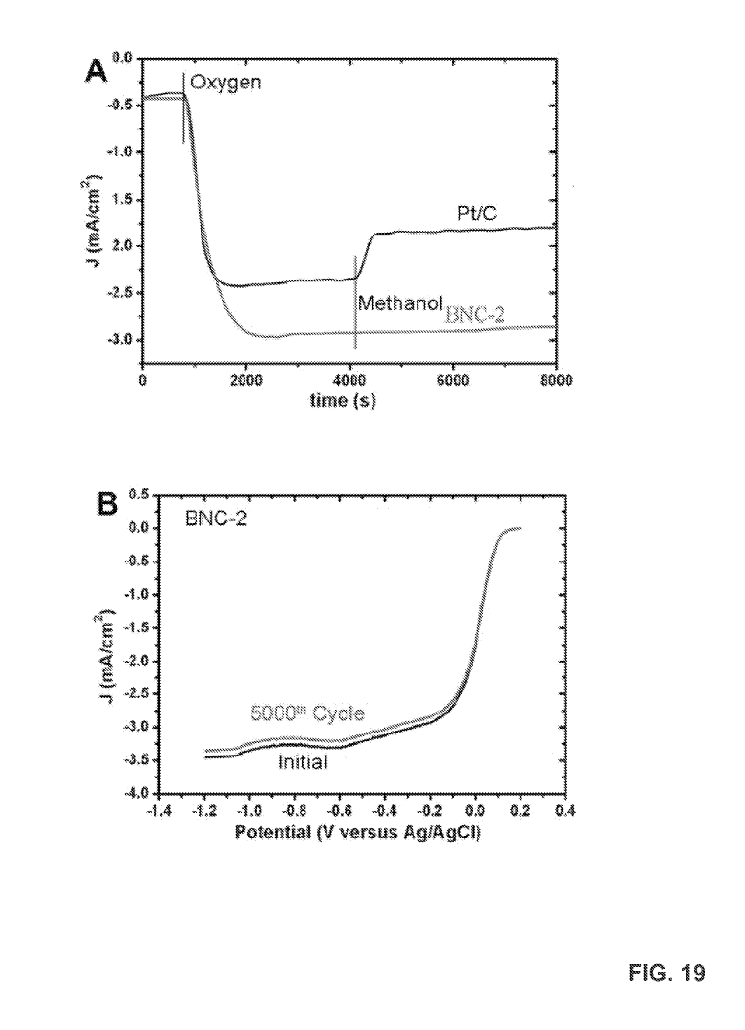

To evaluate the properties of BNC NRs for ORRs, the crossover effect was also considered since the fuel in the anode (e.g., methanol or glucose) might permeate through the polymer membrane to the cathode and seriously affect the performance of the ORR catalysts. Thus, the electrocatalytic sensitivity of BNC-2 NRs and commercial Pt/C catalysts were measured against the electro-oxidation of methanol in ORR. As shown in FIG. 19A, current density-time responses were used to detect the effect of oxygen and methanol. Both of them have a strong response to O₂. However, a significant decrease in current density is observed for the Pt/C catalyst in O₂-saturated 0.1 M KOH solution when 3M methanol is added, whereas no noticeable response for BNC-2 NRs is detected. Apparently, BNC-2 NRs show a good selectivity for ORR and, thus, a remarkably better tolerance of crossover effect against methanol than commercial Pt/C catalysts. More importantly, the durability of the BNC architecture is much better than that of Pt-C. As shown in FIG. 19B, after 5000 continuous cycles, both the onset potential and the half-wave potential almost overlap with the first cycle, demonstrating the robust durability of the BNC NR for ORR.

In summary, Applicants have demonstrated that boron and nitrogen-doped graphene nanoribbons show optimal ORR electrocatalytic activity that is better than commercial Pt-C catalysts. The high activity, optimal tolerance to methanol, high durability and high half-wave potential are achieved for optimally doped (10 wt % BN) BNC NR catalysts in comparison to other metal-free catalysts in alkaline solution.

### EXAMPLE 1.1

### Synthesis of Graphene Oxide Nanoribbons (GONR)

The water-dispersible GONR used in this example were prepared by unzipping multiwalled carbon nanotubes with a solution-based oxidative process. The details can be found in the literature. Nature, 458, 872-875 (2009).

### EXAMPLE 1.2

### Fabrication of GONR Aerogels

GONR aerogels were synthesized by a hydrothermal self-assembly procedure. In a typical procedure, 10 mg of GONR was dispersed in 5 mL H₂O by bath sonication (Cole Parmer, model 08849-00) for 30 min. The resulting mixture was sealed in a Telfon-lined autoclave and hydrothermally treated at 180° C. for 6 h. Finally, the as-prepared samples were freeze-dried to preserve the 3D architecture.

### EXAMPLE 1.3

### BNC NR Aerogels from GONR Aerogels

The conversion reaction was carried out in a standard 1 in. quartz tube under high temperature. GONR aerogels were loaded into a vacuum quartz tube. After the tube was evacuated to 100 mTorr, the tube was heated to 1000° C. in 40 min and then kept at 1000° C. during the reaction. Solid boric acid was put in a lower temperature zone as a boron source. 50 sccm ammonia gas was used as the source of nitrogen. The doping level of BN can be controlled by adjusting reaction times from 15 minutes to 1 hour. The annealing reaction removes most of the oxygen from the GONR aerogels such that the products resemble GNRs.

### EXAMPLE 1.4

### Electrochemical Measurements

2 mg of BNC aerogel catalysts and 2 mL of 0.5 wt % Nafion aqueous solution were mixed and dispersed by bath sonication for 1 hour to form a homogeneous suspension. CV and RRDE studies were conducted in an electrochemical cell (AUTO LAB PGSTAT 302) using an Ag/AgCl electrode as the reference electrode and a Pt wire as the counter electrode. For CV and RRDE tests, 8 μL of the catalyst suspension was loaded onto a glassy carbon electrode (5 mm in diameter). A flow of O₂ was maintained over the electrolyte during the measurement to ensure continuous O₂ saturation. For all RRDE measurements, the electrode rotation speed was 900 rpm (scan rate, 5 mV/s; platinum data collected from anodic sweeps).

Commercial 20 wt % platinum on Vulcan carbon black (Pt/C from Alfa Aesar) was measured for comparison. All the parameters for Pt/C measurements are the same as those for BNC NR aerogels.

### EXAMPLE 1.5

### Characterization

The morphology and microstructure of the samples were systematically investigated by FE-SEM (JEOL 6500), TEM (JEOL 2010), STEM (Nion UltraSTEM-100), AFM (Digital Instrument Nanoscope IIIA), XPS (PHI Quantera x-ray photoelectron spectrometer) and XRD (Rigaku D/Max Ultima II Powder X-ray diffractometer) measurements. Raman spectroscopy (Renishaw inVia) was performed at 514.5 nm laser excitation at a power of 20 mW. Nitrogen adsorption isotherms and BET surface areas were measured at 77 K with a Quantachrome Autosorb-3B analyzer (USA).

### EXAMPLE 1.6

### Density Functional Calculations

The spin-polarized density functional theory (DFT) calculations are performed using the Vienna ab-initio Simulation Package (VASP) with the Perdew-Burke-Ernzerhof parametrization (PBE) of the generalized gradient approximation (GGA) and projector-augmented wave (PAW) potentials. Adopting the supercell approach, Applicants chose a vacuum layer thickness larger than 10 Å to keep the spurious interactions negligible. GNRs with widths of eight zigzag chains and periodic length of six primitive units were chosen as models. Using the plane-wave-based total energy minimization, all structures are fully relaxed until the force on each atom is less than 0.01 eV/Å. The models shown in Example 1 have been determined to be the most stable structures by comparing energies of different configurations with the same doping concentrations.

Following the same scheme as proposed previously, the free energy of O₂ is derived as G(O₂)=2G(H₂O)−G(H₂)−4.92 eV, where 4.92 eV is taken from the free energy change of reaction O₂+2H₂→2H₂O under the standard condition. The free energy of OH⁻ is determined as G(OH⁻)=G(H₂O)−G(H⁺), assuming H⁺+OH⁻→H₂O is in equilibrium. By setting the reference potential to be that of the standard hydrogen electron (pH=0 in the electrolyte, 1 bar of H₂ in the gas phase at 298K), the free energy of H⁺, G(H⁺), is related to half of hydrogen molecule, G(H₂)/2. At a pH different from 0, G(H⁺) is corrected by the concentration dependence of the entropy, G(pH)=kTLn[H⁺]=−kTLn10×pH. The effect of the bias is included for all states involving electrons in the electrode, by shifting the energy of this state by −neU, where n and U are the number of electrons involved and the electrode potential, respectively. Applicants determined free energies of intermediates at U=0 V as ΔG=ΔE+ΔZPE−TAS, where ΔE, ΔZPE and ΔS are the difference in total DFT energies, zero point energies due to reactions, and the change of the entropy. Under these approximations, the maximum potential achieved by thermodynamics is ˜0.4 eV at pH=14, which is consistent with the standard reduction potential of the ORR in alkaline solution.

### EXAMPLE 1.7

### Analysis of the O₂ Binding

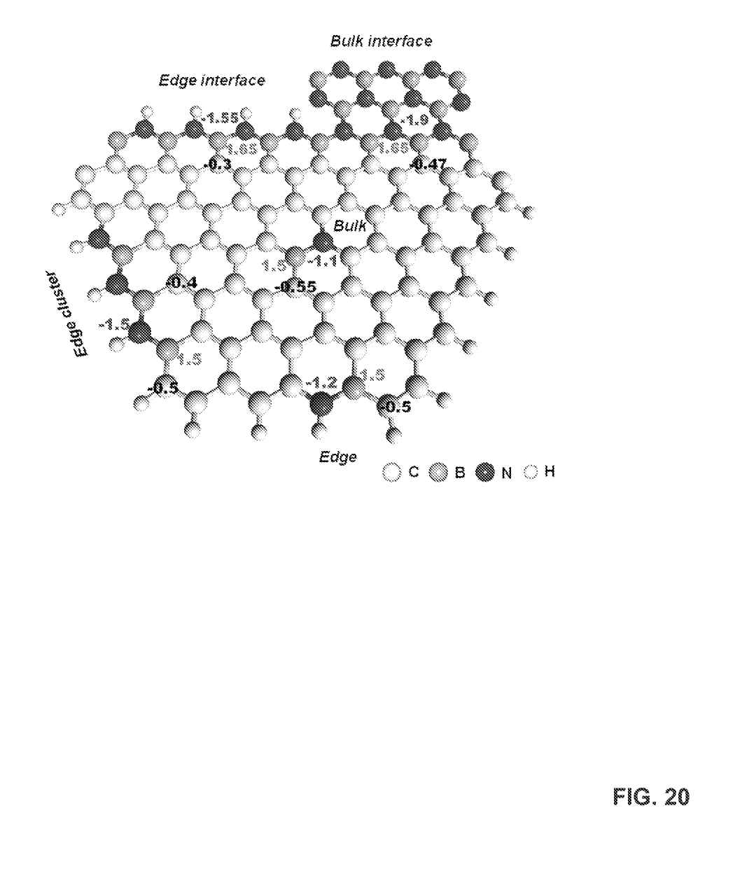

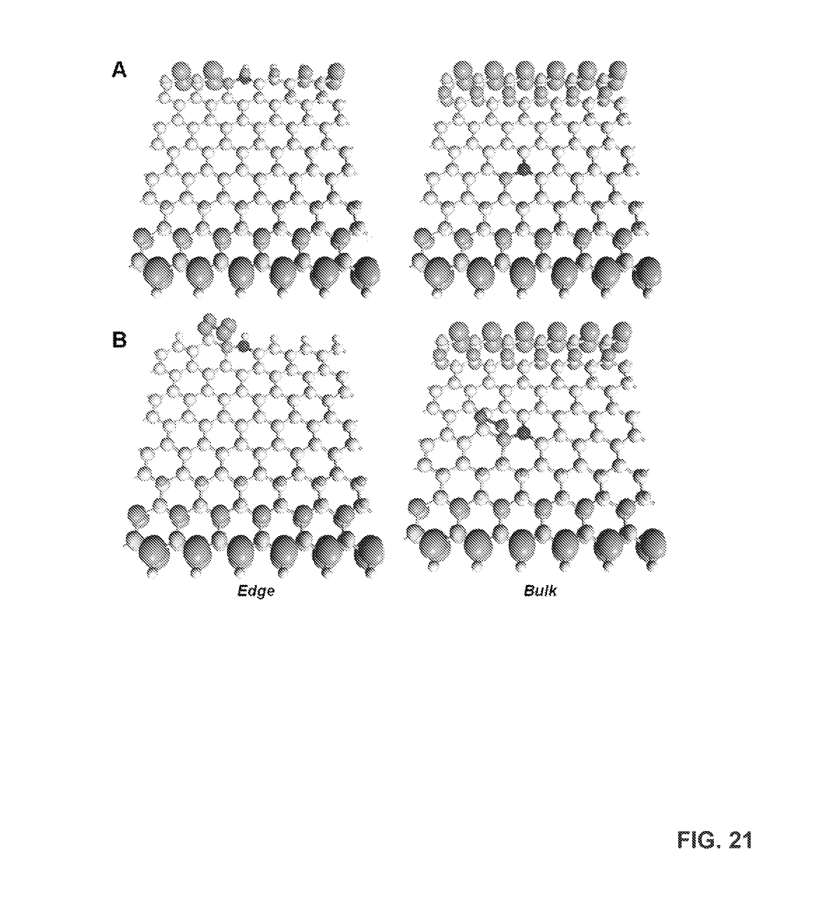

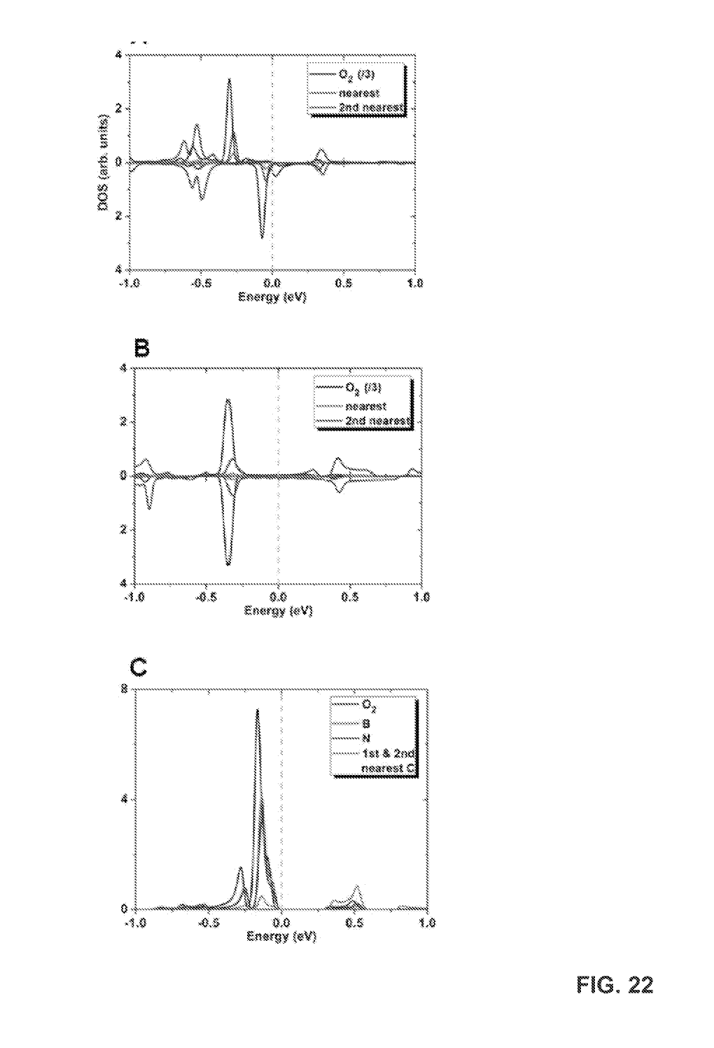

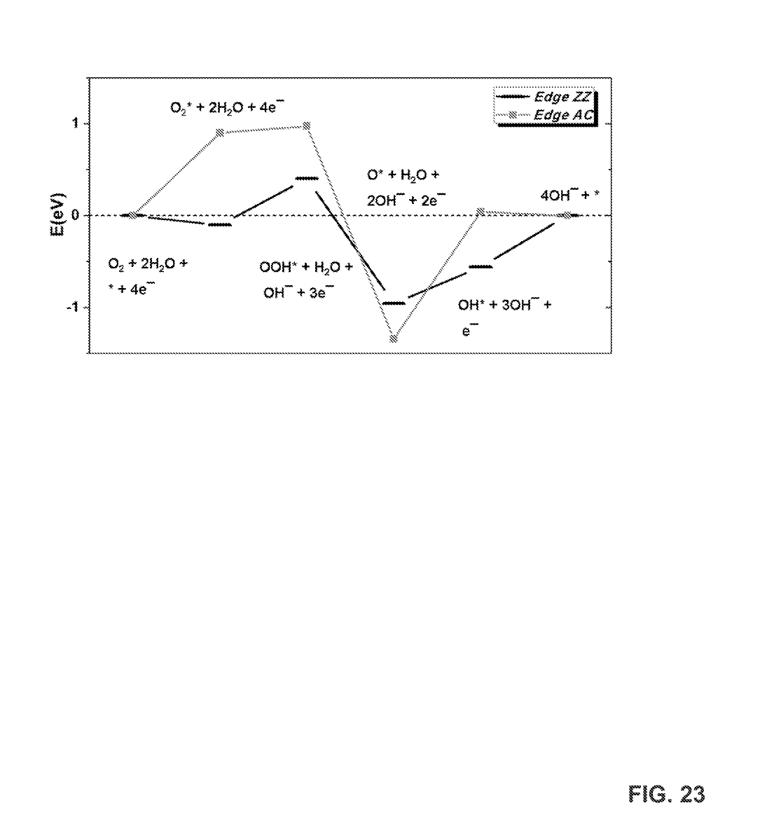

To further understand the underlying mechanism of O₂ binding to electrocatalysts, the Bader charge analysis was performed (FIG. 20). The analysis shows that the substitutional B sites possess positive charges, which is beneficial for the adsorption of O₂ that would acquire electron upon adsorption. While this effect from the disturbation of charge neutrality of graphene matrix is similar in both the Bulk and Edge cases due to the similar positive charge (˜+1.5 e) for these B, the nearest edge C atom also has significant amount of spin charge, in sharp contrast to the Bulk case where the nearest C has negligible spin polarization (FIG. 21). The strong spin splitting in the edge C further facilitates their interaction with O₂ with triplet spin ground state. The effective interaction between them is verified by the much stronger broadening of the O₂ states in the Edge case compared with Bulk case (FIG. 22). This is also in line with much weaker O₂ binding in the non-magnetic armchair edge doping case (Edge AC in FIGS. 22-23).

In FIGS. 22A-B, DOS is projected to adsorbed O₂ molecule. The B and C atoms are directly bonded to O₂ (Nearest in the plots) and those bonded to the nearest ones (2nd nearest in the plots). The values for O₂ are divided by three for better comparison. For the Edge ZZ case, the DOS near the Fermi level for O₂ displays strong broadening, indicating efficient hybridization with electronic states of the substrates, especially with those of the 2nd nearest atoms which are mainly contributed by the p_{z}, orbitals. Thus, the O₂ effectively interact with the it electrons of the graphene in this case. In contrast, in the Bulk case, the DOS for O₂ is well-localized, resembling molecular levels. In the Edge AC case, the interaction between O₂ and the π electrons is rather small, as manifested by the small DOS contribution from the C atoms around the O₂ molecule (olive line).

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A Method of mediating an oxygen reduction reaction,
wherein the method comprises exposing a catalyst to oxygen, wherein the catalyst comprises:
a carbon source; and
a dopant associated with the carbon source.

2. The method of claim 1, wherein the catalyst further comprises a plurality of active sites for mediating the oxygen reduction reaction.

3. The method of claim 1, wherein the catalyst consists essentially of the carbon source and the dopant.

4. The method of claim 1, wherein the catalyst is substantially free of metals.

5. The method of claim 1, wherein the exposing of the catalyst to oxygen results in conversion of oxygen to at least one of H₂O, H₂O₂ , O₂⁻, OH⁻, and combinations thereof.

6. The method of claim 1, wherein the carbon source is selected from the group consisting of carbon nanoribbons, graphene nanoribbons, functionalized graphene nanoribbons, graphene oxide nanoribbons, reduced graphene oxide nanoribbons, and combinations thereof.

7. The method of claim 1, wherein the carbon source comprises graphene nanoribbons.

8. The method of claim 1, wherein the dopant is selected from the group consisting of boron, nitrogen, sulfur, phosphorus, heteroatoms thereof, and combinations thereof.

9. The method of claim 1, wherein the dopant is a heteroatom comprising boron and nitrogen.

10. The method of claim 1, wherein the catalyst has a total dopant content of about 2 wt % to about 30 wt %.

11. The method of claim 1, wherein the catalyst has a total dopant content of about 10 wt %.

12. The method of claim 1, wherein the dopant is covalently associated with edges of the carbon source.

13. The method of claim 1, wherein the catalyst has a three-dimensional structure.

14. The method of claim 1, wherein the catalyst has a density ranging from about 1 mg/cm³ to about 10 mg/cm³.

15. The method of claim 1, wherein the catalyst has a surface area ranging from about 100 m²/g to about 1,000 m²/g

16. The method of claim 1, wherein the catalyst is associated with an energy conversion device.

17. The method of claim 16, wherein the energy conversion device is a fuel cell.

18. The method of claim 1, wherein the catalyst has an onset-potential of more than 0.95 V, an electron transfer number between 1 and 4, a half-wave potential between −2 and 1, and a kinetic current density between about 5 mA/cm² and about 10 mA/cm²

19. A catalyst for mediating an oxygen reduction reaction,
wherein the catalyst comprises:
a carbon source; and
a dopant associated with the carbon source.

20. The catalyst of claim 19, wherein the catalyst further comprises a plurality of active sites for mediating the oxygen reduction reaction.

21. The catalyst of claim 19, wherein the catalyst consists essentially of the carbon source and the dopant.

22. The catalyst of claim 19, wherein the catalyst is substantially free of metals.

23. The catalyst of claim 19, wherein the carbon source is selected from the group consisting of carbon nanoribbons, graphene nanoribbons, functionalized graphene nanoribbons, graphene oxide nanoribbons, reduced graphene oxide nanoribbons, and combinations thereof.

24. The catalyst of claim 19, wherein the carbon source comprises graphene nanoribbons.

25. The catalyst of claim 19, wherein the dopant is selected from the group consisting of boron, nitrogen, sulfur, phosphorus, heteroatoms thereof, and combinations thereof.

26. The catalyst of claim 19, wherein the dopant is a heteroatom comprising boron and nitrogen.

27. The catalyst of claim 19, wherein the catalyst has a total dopant content of about 2 wt % to about 30 wt %.

28. The catalyst of claim 19, wherein the catalyst has a total dopant content of about 10 wt %.

29. The catalyst of claim 19, wherein the dopant is covalently associated with edges of the carbon source.

30. The catalyst of claim 19, wherein the catalyst has a three-dimensional structure.

31. The catalyst of claim 19, wherein the catalyst has a density ranging from about 1 mg/cm³ to about 10 mg/cm³.

32. The catalyst of claim 19, wherein the catalyst has an onset-potential of more than 0.95 V, an electron transfer number between 1 and 4, a half-wave potential between −2 and 1, and a kinetic current density between about 5 mA/cm² and about 10 mA/cm²

33. The catalyst of claim 19, wherein the catalyst is associated with an energy conversion device.

34. The method of claim 33, wherein the energy conversion device is a fuel cell.

35. A method of making a catalyst for oxygen reduction reactions, wherein the method comprises:
assembling a carbon source into a three-dimensional structure; and
doping the carbon source with a dopant.

36. The method of claim 35, wherein the carbon source is selected from the group consisting of carbon nanoribbons, graphene nanoribbons, functionalized graphene nanoribbons, graphene oxide nanoribbons, reduced graphene oxide nanoribbons, and combinations thereof.

37. The method of claim 35, wherein the carbon source comprises graphene nanoribbons.

38. The method of claim 37, wherein the graphene nanoribbons are derived from carbon nanotubes.

39. The method of claim 38, further comprising a step of forming the graphene nanoribbons.

40. The method of claim 39, wherein the graphene nanoribbons are formed by the longitudinal splitting of carbon nanotubes.

41. The method of claim 39, wherein the longitudinal splitting of carbon nanotubes occurs by exposure of the carbon nanotubes to at least one of potassium, sodium, lithium, alloys thereof, metals thereof, salts thereof, and combinations thereof.

42. The method of claim 39, wherein the longitudinal splitting of carbon nanotubes occurs by exposure of the carbon nanotubes to an oxidizing agent.

43. The method of claim 35, further comprising a step of reducing the carbon source.

44. The method of claim 35, wherein the carbon source is assembled into a three-dimensional structure through hydrothermal treatment of the carbon source.

45. The method of claim 35, wherein the dopant is selected from the group consisting of boron, nitrogen, sulfur, phosphorus, heteroatoms thereof, and combinations thereof.

46. The method of claim 35, wherein the dopant is a heteroatom comprising boron and nitrogen.

47. The method of claim 35, wherein the doping comprises associating the carbon source with dopant precursors.

48. The method of claim 47, wherein the associating occurs by annealing.
